(19) United States
(12) Patent Application Publication
(10) Pub. No.: US 2008/0189152 A1
(43) Pub. Date: Aug. 7, 2008

(54) SELECTION METHOD, SELECTION SYSTEM, SELECTION DEVICE AND RECORDING MEDIUM

(75) Inventors: Masahiro HARA, Kawasaki (JP); Tatsuro MATSUMOTO, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi, Kanagawa (JP)

(21) Appl. No.: 11/966,768

(22) Filed: Dec. 28, 2007

(30) Foreign Application Priority Data
Feb. 5, 2007 (JP) 2007-026090

(51) Int. Cl. G06F 17/30

(52) U.S. Cl. 705/7

(57) ABSTRACT

A downstream server stores product information on a radio-frequency (RF) tag outputted from a reader/writer into a database. A processing unit executes various processing using product information stored in the database. If product information necessary for the processing unit to execute various processing is not stored in the database, a transmission request for the product information is outputted to an upstream server. The upstream server transmits the product information stored in a memory unit to the downstream server. The upstream server stores the history of received transmission requests for product information in a history database. The upstream server determines priority rankings for product information, based on the history stored in the history database. The upstream server outputs a predetermined number of pieces of product information having higher priority rankings determined to a reader/writer as information to be written on a RF tag.

### CROSS-REFERENCE TO RELATED APPLICATION

This non-provisional application claims priority under 35 U.S.C. §119(a) on Patent Application No. 2007-026090 filed in Japan on Feb. 5, 2007, the entire contents of which are hereby incorporated by reference.

### BACKGROUND

1. Technical Field

The present invention relates to a selection method and a selection system for selecting product information to be written on a wireless tag by using a selection device and an information processing device connected through a communication network, the selection device, and a recording medium for making the selection device function as a computer.

2. Description of Related Art

In recent years, in the field of logistics management, products are managed by attaching wireless tags to the products and reading information stored in the memories of the wireless tags, or writing necessary information into the memories, with a reader/writer. Logistics management using wireless tags in place of barcodes has become popular rapidly, and the wireless tags are used in various fields in addition to the field of logistics management (see, for example, Patent Document 1).

In the memory of a wireless tag, various pieces of product information such as the product name, price and manufacturer name are stored in addition to unique identification information, and dealers read the product information on the wireless tags with a reader/writer and make good use of the information for inventory management. The wireless tags are handled by a plurality of dealers in the logistics process. For example, in food logistics, an upstream food manufacturer attaches wireless tags to its products and supplies downstream retailers with the products. The downstream retailers receive the products from the food manufacturer and sell the products having the wireless tags to general consumers.

### [Patent Document 1]

Japanese Patent Application Laid-Open No. 2004-515861

However, there may be a case where product information other than the product information stored in the memory of a wireless tag is necessary. For instance, although the product name, price and manufacturer name are stored in the memory of the wireless tag, a retailer may further require other product information such as the manufacture date, expire date or ingredients of the product (food). Also, there may be a case where product information about other product is required. For example, when the product is the main body of a personal computer, product information about a display as a relevant product may be required. In such a case, it was conventionally necessary to send a transmission request for the product information from a computer of a downstream company to a computer of an upstream company connected to the computer of the downstream company through a communication network.

When the computer of the upstream company receives the transmission request, it needs to perform processing, such as authentication of the computer of the downstream company, accessing a database, protocol conversion, and transmission of converted data to the computer of the downstream company. Hence, there is a problem that both the upstream and downstream computers have larger processing burdens that prevent rapid logistics management. If various pieces of product information are all stored in the memory of a wireless tag, the problem would be solved, but there is a limit on the capacity of the memory. It should be noted that the technique of Patent Document 1 merely defines a format of information written on a wireless tag, and this document does not disclose any means for solving the above-mentioned problem.

### SUMMARY

The present invention has been made with the aim of solving the above problems, and it is an object of the invention to provide a selection method, a selection system and a selection device capable of reducing communication traffic between dealers and achieving more rapid logistics management by determining priority rankings of product information to be written, based on the history of transmission requests for the product information, and to provide a recording medium storing a program for making the selection device function as a computer.

Another object of the invention is to provide a selection system capable of more accurately selecting product information to be written on a wireless tag by notifying product information of high necessity and modifying the priority rankings based on this information.

Still another object of the invention is to provide a selection device that calculates correlation values between different pieces of product information and appropriately changes the priority rankings according to the correlation values, thereby capable of more accurately selecting product information to be written on a wireless tag for product information having strong correlation.

A selection method according to the present invention for selecting, using a selection device and an information processing device connected through a communication network, product information to be written on a wireless tag from a memory unit of the selection device, comprises: a step of transmitting product information stored in the memory unit of the selection device to the information processing device when the selection device receives a transmission request for product information from the information processing device; a storing step of storing a history of the received transmission request for product information in a history database by the selection device; a determination step of determining priority rankings for product information by the selection device, based on the history stored in the history database; and a step of reading a predetermined number of pieces of product information having higher priority rankings determined in the determination step from the memory unit and outputting the product information as information to be written on a wireless tag from the selection device to a wireless tag writing device.

A selection system according to the present invention comprises a selection device for selecting product information to be written on a wireless tag from a memory unit storing a plurality of pieces of product information, and an information processing device connected to said selection device through a communication network, wherein said selection device comprises: the memory unit; and a processor for executing a process comprising: a step of transmitting product information stored in the memory unit to said information processing device when said selection device receives a transmission request for product information from said information processing device; a storing step of storing a history of the received transmission request for product information in a history database; a determination step of determining priority rankings for product information, based on the history stored in the history database; and a step of outputting a predetermined number of pieces of product information having higher priority rankings determined in the determination step to a wireless tag writing device as information to be written on a wireless tag.

The selection system according to the present invention, wherein said information processing device is connected to a reading device for reading information on a wireless tag, and said information processing device comprises a processing unit for executing a process comprising: a step of storing product information on a wireless tag outputted from the reading device into a database for storing product information; and a request output step of outputting a transmission request for product information to said selection device if product information necessary for said processing unit to execute various processing using product information stored in the database is not stored in the database.

The selection system according to the present invention, wherein the processing unit of said information processing device executes a process comprising: a count step of counting the number of transmission requests for product information outputted to said selection device in the request output step; and a count transmission step of transmitting a predetermined number of pieces of product information having higher counts counted in the count step to said selection device, and a processor of said selection device executes a modification step of modifying the priority ranking determined in the determination step for the product information having higher count transmitted in the count transmission step.

The selection system according to the present invention, wherein the processing unit of said information processing device executes a process comprising: a step of storing in a transmission request history file a response time required until product information is received after outputting a transmission request for the product information to said selection device in association with the product information; and a response time transmission step of transmitting a predetermined number of pieces of product information having longer response time stored in the transmission request history file from said information processing device to said selection device, and the processor of said selection device executes a modification step of modifying the priority ranking determined in the determination step for the product information having longer response time transmitted in the response time transmission step.

The selection system according to the present invention, wherein the processor of said selection device executes a process comprising: a step of transmitting at predetermined intervals to said information processing device a signal for requesting transmission of product information having a higher count in the count transmission step, and wherein upon receipt of the signal, the count transmission step transmits a predetermined number of pieces of product information having higher counts counted in the count step to said selection device.

The selection system according to the present invention, wherein the processor of said selection device executes a step of transmitting at predetermined intervals to said information processing device a signal for requesting transmission of product information having longer response time in the response time transmission step, and wherein upon receipt of the signal, the response time transmission step transmits a predetermined number of pieces of product information having longer response time stored in the transmission request history file to said selection device.

A selection device according to the present invention for selecting product information to be written on a wireless tag, comprises: a memory unit; and a processor for executing a process comprising: a step of transmitting product information stored in the memory unit to an external device upon receipt of a transmission request for product information from the external device; a storing step of storing a history of the received transmission request for product information in a history database; a determination step of determining priority rankings for product information, based on the history stored in the history database; and a step of outputting a predetermined number of pieces of product information having higher priority rankings determined in the determination step to the external device as information to be written on a wireless tag.

The selection device according to the present invention, wherein the determination step determines the priority rankings in order from the product information having highest number of transmission requests in the history of transmission requests for product information stored in the history database.

The selection device according to the present invention, wherein the storing step stores the history of the received transmission requests for product information together with transmission request dates in the history database, and said processor executes a process comprising: a correlation value calculation step of calculating a correlation value between one product information and other product information, based on the transmission request dates stored in the history database; and a change step of changing the priority ranking of product information determined in the determination step for one product information or other product information having a higher correlation value calculated in the correlation value calculation step, based on the priority ranking of either the one product information or the other product information.

The selection device according to the present invention, wherein the correlation value calculation step comprises: an extraction step of extracting a combination of one product information and other product information having a difference equal to or smaller than a predetermined value between the transmission request date of the one product information and the transmission request date of the other product information with reference to the history database; a step of counting the number of combinations of one product information and other product information extracted in the extraction step; and a step of outputting the number of combinations counted in the count step as a correlation value between the one product information and other product information.

The selection device according to the present invention, wherein the change step changes the priority ranking of product information determined in the determination step for one product information or other product information having a higher correlation value calculated in the correlation value calculation step to the priority ranking of either the one product information or the other product information having higher priority.

A selection device according to the present invention for selecting product information to be written on a wireless tag, comprises: means for transmitting product information stored in a memory unit to an external device upon receipt of a transmission request for product information from the external device; memory means for storing a history of the received transmission request for product information in a history database; determining means for determining priority rankings for product information, based on the history stored in the history database; and means for outputting to the external device a predetermined number of pieces of product information having higher priority rankings determined by said determining means as information to be written on a wireless tag.

A recording medium according to the present invention readable by a computer and storing a program for causing a computer to select product information to be written on a wireless tag and execute a process comprises: a step of transmitting product information stored in a memory unit to an external device upon receipt of a transmission request for product information from the external device; a storing step of storing a history of the received transmission requests for product information in a history database; a determination step of determining priority rankings for product information, based on the history stored in the history database; and a step of outputting a predetermined number of pieces of product information having higher priority rankings determined in the determination step to the external device as product information to be written on a wireless tag.

The recording medium according to the present invention, wherein the program causes the computer to execute a process comprising: a step of storing product information on a wireless tag outputted from an external device into a database for storing product information; and a request output step of outputting a transmission request for product information to an external device when a processing section for executing various processing using product information stored in the database determines that product information necessary for executing the processing is not stored in the database.

According to the present invention, a selection system comprises a selection device for selecting product information to be written on a wireless tag, and an information processing device connected to the selection device through a communication network. The information processing device is connected to a reader for reading information on a wireless tag. The information processing device stores the product information on a wireless tag outputted from the reader into a database for storing product information. A processing unit executes various processing by using the product information stored in the database. If product information required by the processing unit to execute various processing is not stored in the database, the request output step is performed to output a transmission request for the product information to the selection device.

When the selection device receives the transmission request for the product information, it transmits the product information stored in the memory unit to the information processing device in response to this request. The selection device stores the history of the received transmission request for the product information in the history database. The determination step determines the priority ranking for the product information, based on the history stored in the history database. The determination step determines the priority rankings in order from the product information with highest number of transmission requests in the history of transmission requests for product information stored in the history database. Finally, the selection device outputs a predetermined number of pieces of product information having higher priority rankings determined to a wireless tag writing device as information to be written on a wireless tag.

According to the present invention, the number of transmission requests for product information outputted to the selection device in the request output step is counted in the count step performed by the information processing device. The count transmission step is performed to transmit product information with a higher count from the information processing device to the selection device. The modification step performed by the selection device modifies the priority ranking determined in the determination step for product information having a higher number of transmission requests.

According to the present invention, the history database stores the history of received transmission requests for product information together with the transmission request dates. The correlation calculation step performed by the selection device calculates a correlation value between one product information and other product information, based on the transmission request dates stored in the history database. Then, the selection device changes the priority ranking of product information determined in the determination step for one product information or other product information having a high correlation value calculated in the correlation value calculation step, based on the priority ranking of either the one product information or the other product information.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view showing an outline of a selection system;

FIG. 2 is a block diagram showing the hardware structures of an upstream server and a RF tag;

FIG. 3 is an explanatory view showing the record layout of a product information DB;

FIG. 4 is an explanatory view showing the record layout of a history DB;

FIG. 5 is an explanatory view showing the record layout of a priority ranking file;

FIG. 6 is a block diagram showing the hardware structure of a downstream server;

FIG. 7 is an explanatory view showing the record layout of a product information DB in the downstream server;

FIGS. 8A and 8B are a flowchart showing the steps of a product information transmission request process;

FIG. 9 is a flowchart showing the steps of a priority ranking determination process;

FIG. 10 is a block diagram showing the hardware structures of an upstream server and a RF tag according to Embodiment 2;

FIG. 11 is an explanatory view showing the record layout of a correlation value file;

FIG. 12 is a flowchart showing the steps of a correlation value calculation process;

FIG. 13 is a flowchart showing the steps of the process of changing the priority ranking;

FIG. 14 is a graph showing the relationship between the transmission request dates of respective pieces of product information;

FIG. 15 is a flowchart showing the steps of a correlation value calculation process;

FIG. 16 is a block diagram showing the hardware structure of a downstream server according to Embodiment 3;

FIG. 17 is an explanatory view showing the record layout of a transmission request history file;

FIG. 18 is a flowchart showing the steps of the process of modifying the priority ranking based on the number of transmission requests;

FIG. 19 is a flowchart showing the steps of the process of modifying the priority ranking based on the response time;

FIG. 20 is a flowchart showing the steps of the process of modifying the priority ranking according to Embodiment 4;

FIG. 21 is a flowchart showing the steps of the process of modifying the priority ranking according to Embodiment 4; and

FIG. 22 is a block diagram showing the structure of an upstream server according to Embodiment 5.

### DETAILED DESCRIPTION

### Embodiment 1

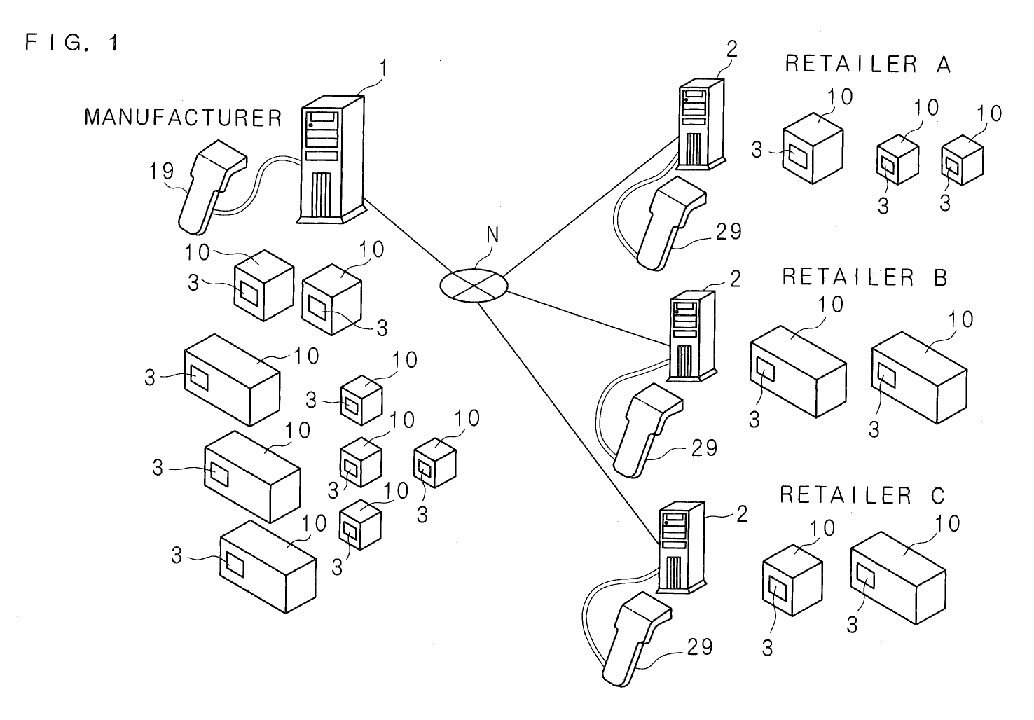

The following will explain an embodiment of the present invention with reference to the drawings. FIG. 1 is a schematic view showing an outline of a selection system according to the present invention. Although the following explains the embodiment by giving an example in which wireless tags are attached to products, such as the main body of a personal computer, a display or a memory, this is merely one example and the embodiment is not limited to this. The selection system comprises a wireless tag 3 (hereinafter referred to as the RF tag 3, RFID: Radio Frequency Identification tag, RF IC tag) attached to a product such as a main body of personal computer, a selection device 1, information processing devices 2, 2, 2 . . . connected to the selection device 1 through a communication network N such as the Internet, a reader/writer 19 and a reader/writer 29 . . . as reading devices for reading the information stored on RF tags 3 and writing devices for writing information to RF tags 3. Note that the wireless tag is not limited to the above-mentioned one if it is means using an identifier and having a rewritable area, such as an IC tag, IC card and rewritable barcode.

A manufacturer writes necessary product information to a RF tag 3 storing unique identification information (hereinafter referred to as the ID), through the reader/writer 19 connected to the selection device 1. For example, the product information may include items, such as the price, manufacture date and manufacture factory, and data corresponding to the respective items (1000 yen, manufactured on 2006/12/11, manufactured in the S Factory) in addition to the product name. The RF tag 3 storing predetermined information is attached to a product 10. This embodiment is explained based on an example in which a passive RF tag 3 in the form of a label is attached to the product 10. However, the RF tag 3 is not limited to this and can be in the form of a card, stick or coin, or even an active RF tag 3.

The manufacturer delivers the products 10 with the attached RF tags 3 to a retailer A, a retailer B and a retailer C. The retailer A reads the ID and product information from the RF tags 3 by using the reader/writer 29 connected to the information processing device 2. For the above-mentioned selection device 1 and information processing device 2, for example, server computers are used. In the following description, the selection device 1 and the information processing device 2 are explained as an upstream server 1 and a downstream server 2, respectively. The downstream server 2 executes various processing by using the read product information. For example, in order to sell a personal computer to a user, the downstream server 2 performs the process of adding up the price of the main body of the personal computer and the price of a display. Moreover, since some user adds a memory, the downstream server 2 performs the process of adding the price of the memory.

When the prices of the main body of the personal computer, display and memory are all stored on the RF tag 3, the downstream server 2 can execute the addition process without accessing the upstream server 1 of the manufacturer. However, if only the price of the main body of the personal computer is stored on the RF tag 3, the downstream server 2 sends a transmission request for product information (the prices of the display and memory) to the upstream server 1 through the communication network N. The upstream server 1 transmits the stored product information to the downstream server 2 in response to the transmission request. The upstream server 1 stores the history of the transmission request, determines priority ranking based on the history, and stores necessary product information on the RF tag 3 according to the determined priority ranking.

In this embodiment, although the selection device 1 of the manufacturer and the information processing devices 2 of the retailers A, B and C are explained as the upstream server 1 and the downstream servers 2, respectively, the present invention is not limited to this embodiment. There are a plurality of stores a, b, c . . . of the retailer A in the downstream of the retailer A, and the stores a, b, c . . . are provided with information processing devices in the same manner. In this case, the information processing device 2 of the retailer A functions as an upstream selection device 1 (upstream server 1), while the store a functions as a downstream information processing device 2 (downstream server 2). In other words, there is a case where the downstream server 2 functions as the upstream server 1. Similarly, there is a case where the upstream server 1 of the manufacturer functions as a downstream server 2 of a further upstream selection device 1. In this embodiment, the explanation is given on the basis that the upstream server 1 of the manufacturer and the downstream server 2 of the retailer A perform substantially the same function. Moreover, although this embodiment is explained by only referring to the manufacturer and retailers as examples, a transportation company can be present between the manufacturer and the retailers, and the transportation company can have a server functioning as the upstream server 1 and downstream server 2.

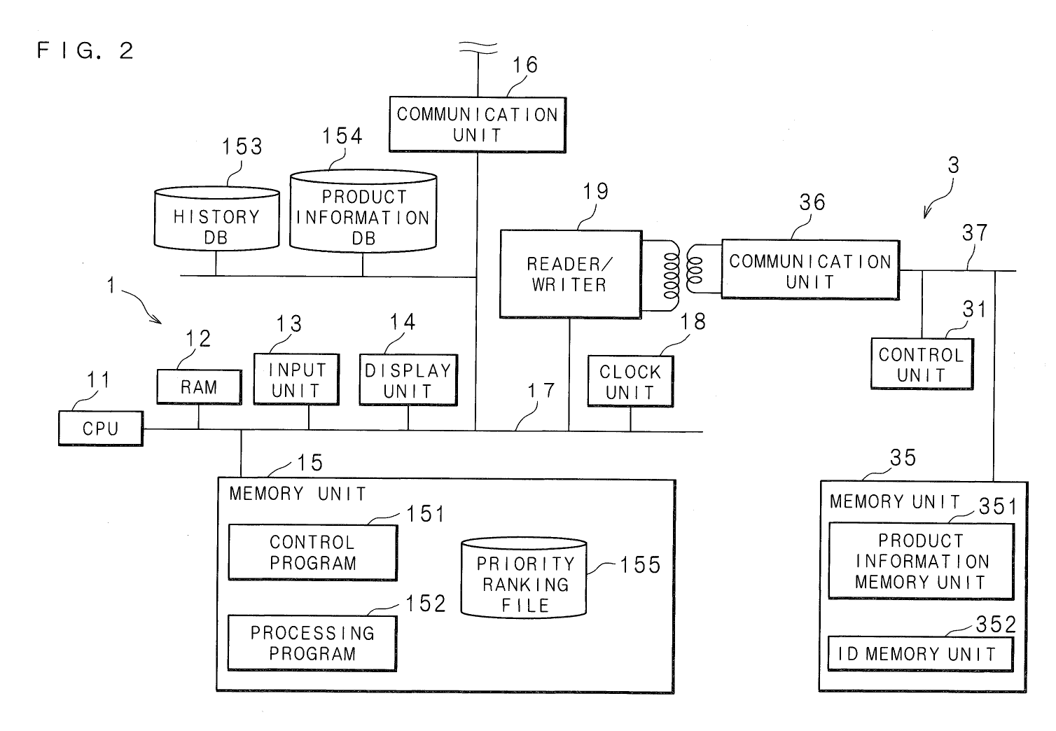

FIG. 2 is a block diagram showing the hardware structures of the upstream server 2 and the RF tag 3. The RF tag 3 comprises a control unit 31, a communication unit 36, and a memory unit 35. The control unit 31 is composed of a logic circuit, and controls the communication unit 36 and memory unit 35 connected through a transmission line 37, according to an internal program. The communication unit 36 is composed of a coil and a RF circuit for wireless communications, and transmits and receives the ID, product information etc. to/from the reader/writer 19.

The memory unit 35 is composed, for example, of an EEPROM (Electronically Erasable and Programmable Read Only Memory), an FeRAM (Ferroelectric Random Access Memory) or a flash ROM, and stores therein a product information memory unit 351 and an ID memory unit 352. In the ID memory unit 352, an identification number uniquely given to the RF tag 3 is stored. In the product information memory unit 351, product information such as, for example, the product name “oo”, the item “Price”, data “2000 yen” corresponding to the item, etc. are stored. The product information is transmitted from the reader/writer 19, and the control unit 31 stores the product information received through the communication unit 36 into the product information memory unit 351. Moreover, the control unit 31 outputs the product information stored in the product information memory unit 351 to the reader/writer 29 in the downstream server 2 through the communication unit 36.

Next, the structure of the upstream server 1 will be explained. The upstream server 1 comprises a CPU 11 as a processing unit, a RAM 12, an input unit 13, a display unit 14, a clock unit 18, a communication unit 16, and a memory unit 15. The CPU 11 is connected to the hardware units in the upstream server 1 through a bus 17, controls the units, and executes various software functions according to a control program 151 and a processing program 152 stored in the memory unit 15.

The display unit 14 is, for example, a liquid crystal display, and the input unit 13 includes a keyboard, a mouse etc. The communication unit 16 is a gateway or the like functioning as a firewall. The clock unit 18 outputs the current time information to the CPU 11. The memory unit 15 is composed, for example, of a hard disk, and stores therein the above-mentioned control program 151, processing program 152 and a priority ranking file 155. A history database (hereinafter referred to as the history DB) 153 and a product information database (hereinafter referred to as the product information DB) 154 are also connected as memory sections to the communication unit 16. The CPU 11 executes processing, such as storing and searching for necessary information, by an interactive function using SQL (Structured Query Language) in a schema relating the keys of the fields of the history DB 153 and product information DB 154. Note that the history DB 153 and product information DB 154 used by the upstream server 1 can also be stored in the memory unit 15, and the priority ranking file 155 stored in the memory unit 15 can also be stored in a database, not shown, outside the memory unit 15.

The reader/writer 19 is connected to the upstream server 1 through an interface, not shown. The reader/writer 19 is a known device, and outputs product information to be written on a RF tag 3 to the communication unit 36 of the RF tag 3, according to an instruction of the CPU 11 of the upstream server 1. The reader/writer 19 also receives the ID and product information outputted from the RF tag 3 through the communication unit 36. The received product information is outputted to the upstream server 1, and the CPU 11 executes predetermined processing using the outputted ID and product information.

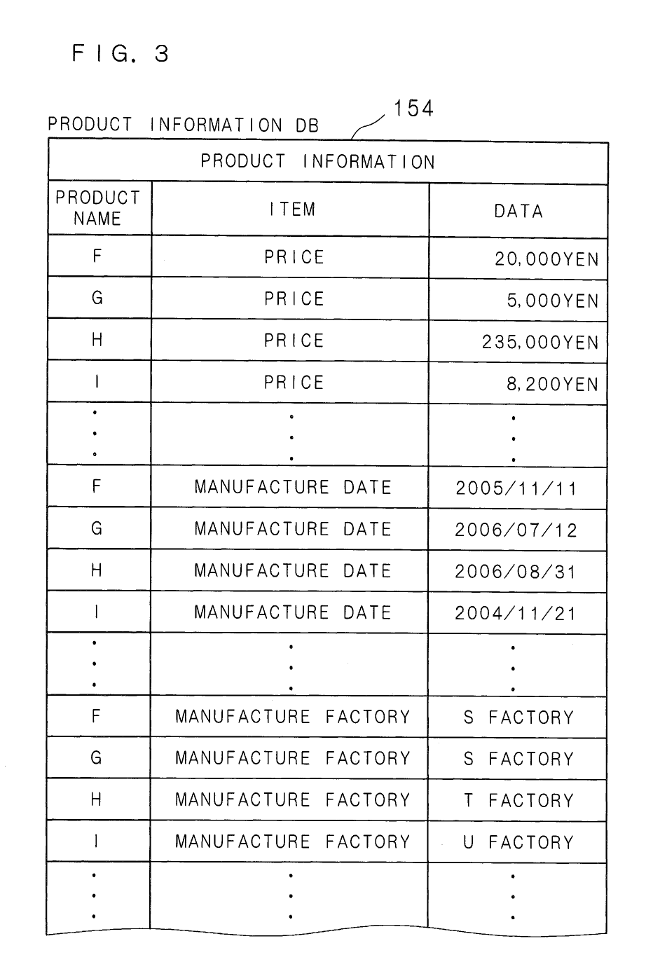

FIG. 3 is an explanatory view showing the record layout of the product information DB 154. As for the product name, item and data as the product information, an item and data are stored in association with the product name in the product information DB 154. In the Item field, the price, manufacture date, and manufacture factory are stored as the items in association with the product names. In the Data field, data about items, for example, data such as 5000 yen is stored if the item is the price, 2005/11/11 is stored if the item is the manufacture date, or S Factory is stored if the item is the manufacture factory, in association with the product name and item. As for the product information about product F, for example, 20000 yen, 2005/11/11 and S Factory are stored as the price, manufacture date, and manufacture factory, respectively.

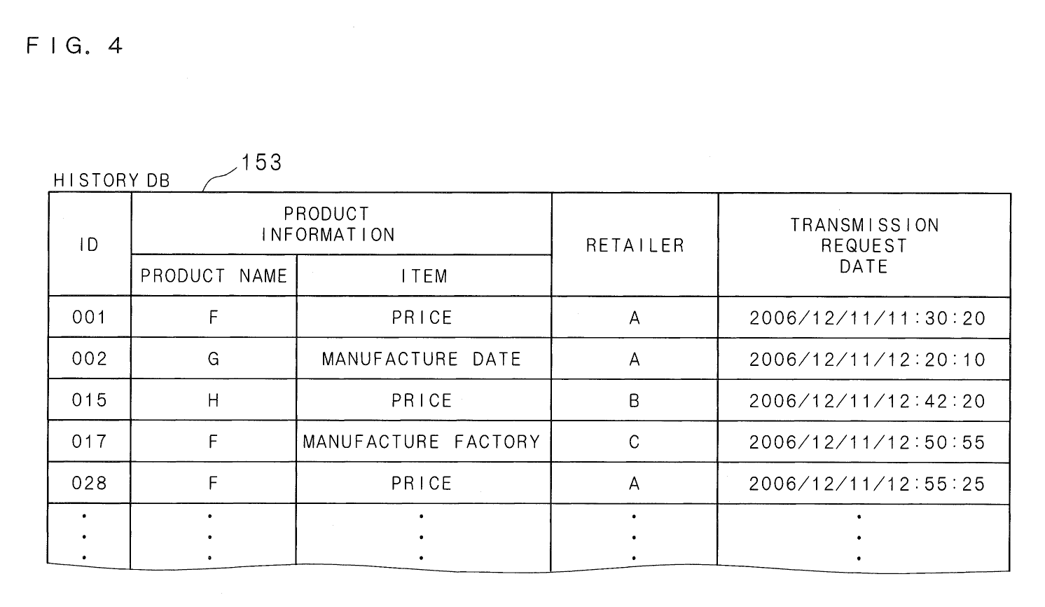

FIG. 4 is an explanatory view showing the record layout of the history DB 153. When the CPU 11 receives a transmission request for product information through the communication unit 16 from the downstream server 2 of the retailer A, retailer B or retailer C, it stores the history in the history DB 153. The transmission request transmitted from the downstream server 2 includes information identifying the retailer who is using the downstream server 2, the ID of the RF tag 3, and information such as a desired product name and item to be transmitted. The history DB 153 includes the ID field, Product Name field, Item field, Retailer field, and Transmission Request Date field. In the ID field, the ID of a RF tag 3 corresponding to product information for which a transmission request was made is stored.

In the Product Name field and Item field, the product name and item are stored as product information in association with the ID. In the Retailer field, the name of a retailer who made the transmission request is stored. In the Transmission Request Date field, the information about the date at which the transmission request was made is stored. When the transmission request was received through the communication unit 16, the CPU 11 refers to the date information outputted from the time unit 18 and stores the information in the history DB 153. As for the ID “001”, for example, a RF tag 3 storing the ID “001” is read with the reader/writer 29 in the downstream server 2 of the retailer A, and the downstream server 2 sends a transmission request for product information to the upstream server 1 in order to request the product information about product name F and the price (price data) of product name F.

The CPU 11 of the upstream server 1 receives the transmission request, and stores the ID “001”, product name “F”, item “Price”, retailer “A”, and transmission request date “2006/12/11/11:30:20” in the transmission request into the history DB 153. Then, the CPU 11 searches the product information DB 154 based on the product name and item of the transmission request, and transmits the searched data corresponding to the product name and item (in this example, the price of 20000 yen of product name “F”) to the downstream server 2 of the retailer A through the communication unit 16.

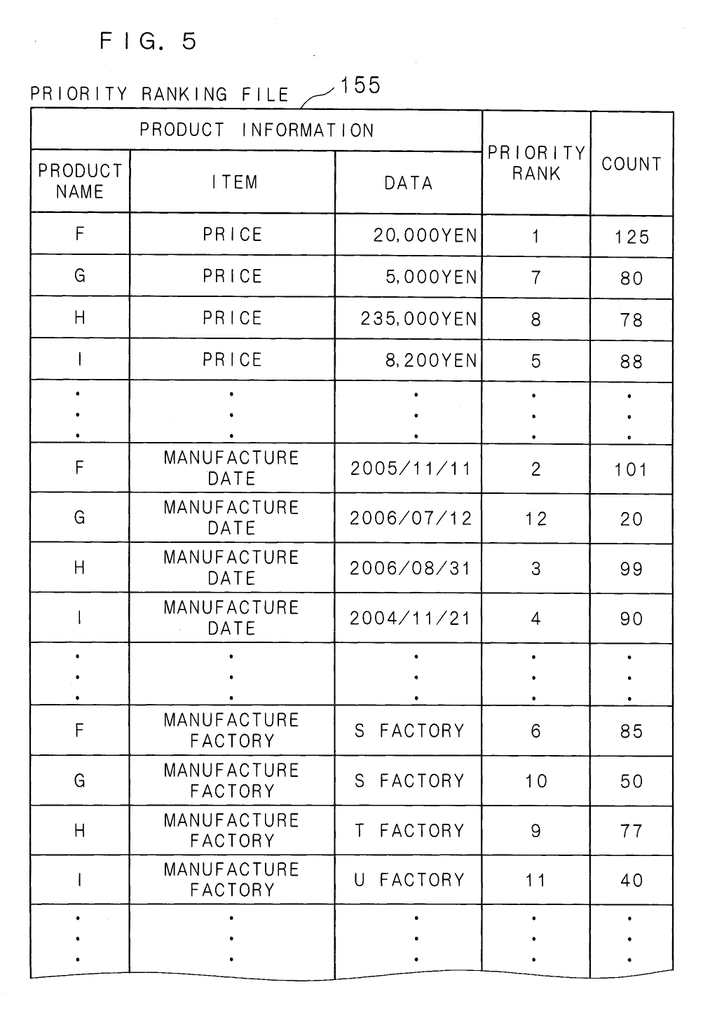

The CPU 11 stores the history about the transmission request for the product information, determines priority rankings for product information based on the history, and outputs a predetermined number of pieces of product information with higher priorities to the reader/writer 19. The determination of priority rankings is made so that the larger the number of transmission requests, the higher the priority. FIG. 5 is an explanatory view showing the record layout of the priority ranking file 155. The priority ranking file 155 includes the Product Name field, Item field and Data field as product information, the Priority Ranking field, and the Count field. Similarly to the product information DB 154 explained along with FIG. 3, an item and data are stored in association with the product name in the Product Name field, Item field and Data field.

When transmission requests are made for specific product information, the number of the transmission requests is stored in the Count field. When product information corresponding to a new transmission request is stored in the history DB 153, the CPU 11 searches, based on the newly stored product name and item, the priority ranking file 155 and increases the count corresponding to the product name and item in the priority ranking file 155 matching the stored product name and item. For example, when the product name “F” and item “Price” are stored for the ID “028” in the history DB 153 shown in FIG. 4, the CPU 11 increases (increments) the count in the Count field corresponding to the product name “F” and item “Price” shown in FIG. 5. In this example, 125 transmission requests were counted.

In the Priority Ranking field, a priority ranking is stored in association with each piece of product information. The priority rankings are arranged so that the larger the count stored in the Count field, the higher the priority. For instance, for the product name “F” and item “Price” as the product information, 125 and “1” are stored as the count and priority ranking, respectively. The CPU 11 refers to the priority ranking file 155, reads a predetermined number of (for example, two) pieces of product information having higher priorities, and outputs the information to the reader/writer 19. Note that the operator can set a suitable value as the above-mentioned predetermined number through the input unit 13, and the CPU 11 stores the inputted value in the memory unit 15. The reader/writer 19 stores the inputted product information into the product information memory unit 351 in the RF tag 3.

For example, when it is designed to store product information which is ranked first and second in the priority rankings, the product information corresponding to product name “F”, item “Price” and data “20000 yen” which is ranked first in the priority rankings and the product information corresponding to product name “F”, item “Manufacture Date” and data “2005/11/11” which is ranked second in the priority rankings are stored in the product information memory unit 351 of the RF tag 3. When storing the product information ranked third in the priority rankings, the product name “H”, item “Manufacture Date” and data “2006/8/31” are stored in the product information memory unit 351 of the RF tag 3. In this embodiment, although product information about different products is stored on the RF tag 3, it is possible to store only the product information about one product. For example, only the product information relating to the product name “F” can be stored on the RF tag 3. In this example, product information other than product name “F” is not stored, and the product name “F”, item “Manufacture Factory” and data “S Factory” ranked next, that is, sixth in the priority rankings are stored in the product information memory unit 351 of the RF tag 3. In short, the product information about the product names “H” and “I” which is ranked third, fourth and fifth in the priority rankings is not stored. Moreover, in this embodiment, as described in the history DB 153 of FIG. 4, the history of all the transmission requests from the retailers A to C is stored and the priority rankings are determined based on this history, but it is also possible to store the history individually for each retailer and determine the priority rankings separately for each retailer. For instance, when the products 10 are decided to be delivered to the retailer A, it is possible to read the history from the history DB 153 storing the history based on transmission requests from the downstream server 2 of the retailer A and decide product information to be stored on the RF tag 3 in order of priority rankings determined based on the history.

The priority ranking determining algorithm is based on the above-mentioned count of transmission requests, or it is possible to use the algorithm described below. For instance, it is possible to determine the priority rankings after giving a weight separately to each piece of product information. In this case, a coefficient is set for each product information. A larger coefficient is set for product information with higher priority and stored in the product information DB 154. The setting of the coefficient can be entered by the operator through the input unit 13. Then, the CPU 11 multiplies the count stored in the priority ranking file 155 by a coefficient corresponding to the product information stored in the product information DB 154 and stores the value resulting from the multiplication as the modified count in the priority ranking file 155. The CPU 11 determines priority rankings in order from the highest modified count. For example, for the product information ranked seventh in the priority rankings with the count “80” corresponding to the product name “G” and item “Price”, 1.0 is stored as a coefficient. For the product information ranked eighth in the priority rankings with the count “78” corresponding to the product name “H” and item “Price”, 1.1 is stored as a coefficient. The CPU 11 multiplies the count “80” by 1.0 and calculates “80” as the modified count, and multiplies the count “78” by 1.1 and calculates “85.8” as the modified count. Then, the CPU 11 determines priority rankings based on the modified counts. In this example, the priority rankings are reversed.

It is also possible to set a higher weight for newer product information in the history of transmission requests. In this case, the CPU 11 performs the priority ranking determination process periodically, for example, once a week. The coefficient is set so that the value decreases with time, or the coefficient value is the largest in the week the determination process is performed and the second largest in the previous week. The coefficient can also be inputted by the operator through the input unit 13. The CPU 11 refers to the history DB 153 and gives the largest coefficient value to the respective pieces of product information corresponding to the week the determination process is performed. Next, the CPU 11 gives the second largest coefficient to the respective pieces of information corresponding to the previous week. Coefficient values that decrease with time until a predetermined week before the determination process are given to respective pieces of product information, and the total value of the coefficients of respective pieces of product information is calculated. Then, priority rankings are determined in order from the largest total value.

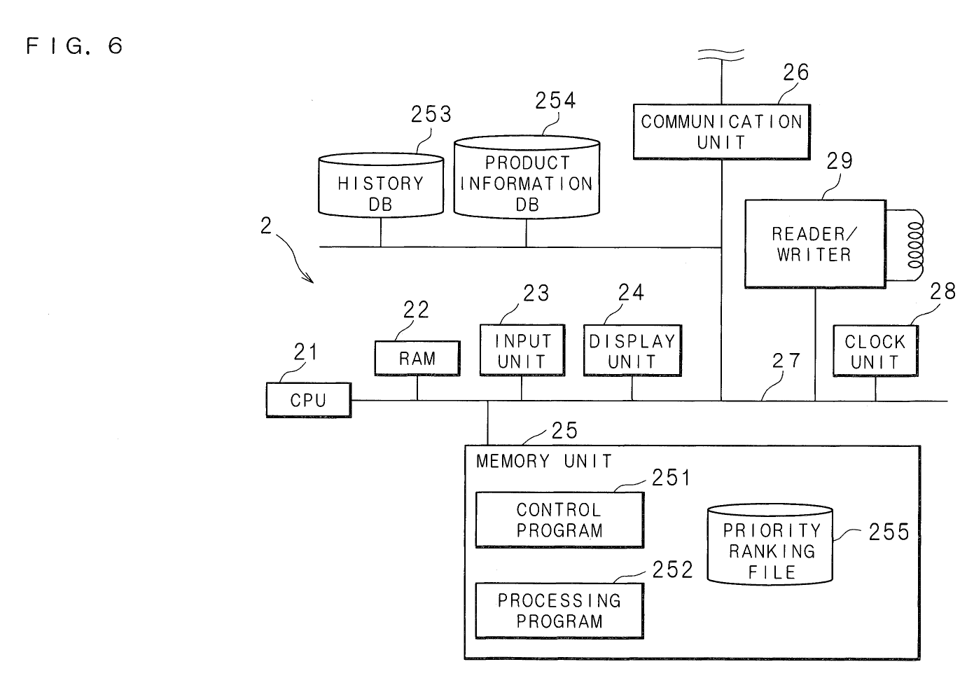

FIG. 6 is a block diagram showing the hardware structure of the downstream server 2. The downstream server 2 comprises a CPU 21 as a processing unit, a RAM 22, an input unit 23, a display unit 24, a clock unit 28, a communication unit 26, and a memory unit 25. The CPU 21 is connected to the hardware units in the downstream server 2 through a bus 27, controls the units, and executes various software functions according to a control program 251 and a processing program 252 stored in the memory unit 25. A priority ranking file 255 is stored in the memory unit 25, and a history DB 253, a product information DB 254 and a reader/writer 29 are connected to the downstream server 2.

Since the hardware structure of the downstream server 2 is the same as that in the upstream server 1, the detailed explanation thereof is omitted. However, since the upstream server 1 and downstream server 2 handle different product information, there are differences in the recorded contents of the history DB 253, product information DB 254 and priority ranking file 255.

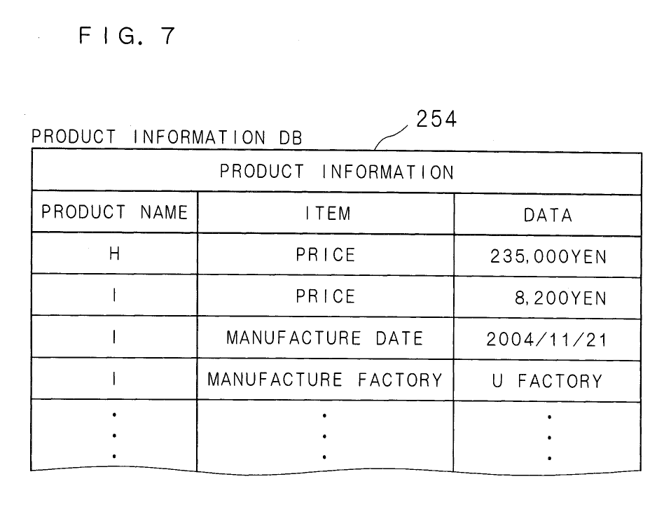

FIG. 7 is an explanatory view showing the record layout of the product information DB 254 in the downstream server 2. Although the layout of the product information DB 254 in the downstream server 2 is similar to that of the product information DB 154 in the upstream server 1, the recorded contents differ from each other. In this example, the recorded contents of the downstream server 2 are less than the recorded contents of the upstream server 1. As shown in FIG. 7, the product information DB 254 stores as the product information: the product name “H”, item “Price” and data “235000 yen”; the product name “I”, item “Price” and data “8200 yen”; the product name “I”, item “Manufacture Date” and data “2004/11/21”; and the product name “I”, item “Manufacture Factory” and data “U Factory”.

Next, the processing program 252 will be explained. The processing program 252 is a program for causing the CPU 21 as a processing unit to execute various processing with reference to the product information DB 254. For example, the processing program 252 executes the process of calculating a total value of the prices of a plurality of products, or the process of calculating the number of days from the manufacture date of a specific product to the current date. The specific processing contents to be executed differ between the processing program 252 and the processing program 152 of the upstream server 1, and the manufacturer and the retailer A, retailer B or retailer C can suitably write a program according to the product information used in its company.

The following will explain an example in which the process of causing the CPU 21 to calculate the total value of the prices of product name “H”, product name “I” and product name “F” is programmed in the processing program 252 in the downstream server 2 of the retailer A. The CPU 11 refers to the product information DB 254 and reads the price “235000 yen” of product name “H” and the price “8200 yen” of product name “I”, because the product information is read from the memory unit 351 of RF tag 3 and stored in the product information DB 254. In the case of the program for calculating the total value of two product name “H” and product name “I”, the CPU 21 can execute the process without accessing the upstream server 1. In this example, however, there is no data about the item “Price” of product name “F” in the product information DB 254.

In this case, the CPU 21 sends to the upstream server 1 through the communication unit 26 a transmission request for the product information, namely the product name “F” and data about the item “Price”. The communication unit 26 transmits to the communication unit 16, via the communication network N, packets including the IP (Internet Protocol) address of the source downstream server 2, the IP address of the destination upstream server 1, desired product information to be transmitted, and a code representing a transmission request by HTTP (Hyper Text Transfer Protocol). The CPU 11 of the upstream server 1 receives the transmission request for the product information through the communication unit 16. Then, the CPU 11 reads the product information from the product information DB 154 and transmits the read product information to the downstream server 2.

In this example, the product name “F” and data “20000 yen” about the item “Price” are transmitted from the upstream server 1 to the downstream server 2. The CPU 21 of the downstream server 2 receives the product name “F” and data “20000 yen” about the item “Price” as the product information, executes the process of calculating the total value of the prices of product name “H”, product name “I” and product name “F”, and obtains the total value “263200 yen”.

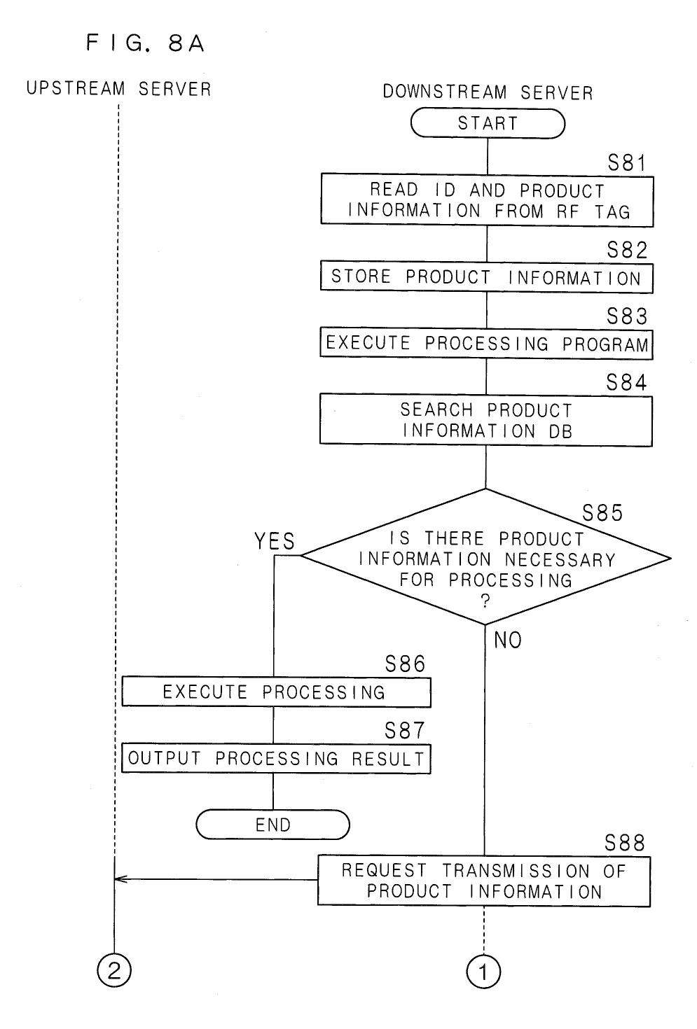

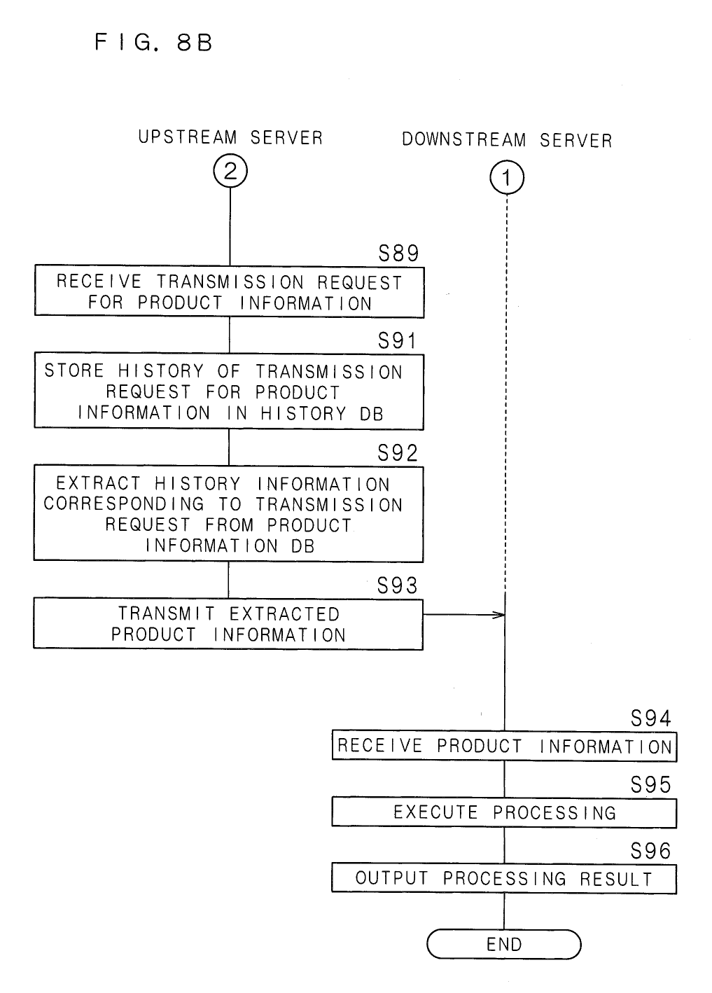

The flow of a sequence of processes between the upstream server 1 and downstream server 2 in the above-mentioned hardware structure will be explained using a flowchart. FIGS. 8A and 8B are a flowchart showing the steps of a product information transmission request process. When the product 10 with the RF tag 3 attached is delivered to the retailer A, the ID and product information are read from the product information memory unit 351 and ID memory unit 352 of the RF tag 3 by using the reader/writer 29 connected to the downstream server 2 (step S81). The ID and product information read by the reader/writer 29 are outputted to the downstream server 2, and the CPU 21 stores the outputted ID and the product information into the memory unit 25 and the product information DB 254, respectively, as shown in FIG. 7 (step S82). The CPU 21 executes the processing program 252 (step S83), and searches the product information DB 254 for product information necessary for processing (step S84).

As a result of search, the CPU 21 determines whether or not there is product information necessary for processing in the product information DB 254 (step S85). When the CPU 21 determines that there is the product information (YES in step S85), it executes processing using the product information according to the processing program 252 (step S86), and outputs the processing result to the display unit 24 etc. (step S87). On the other hand, when the CPU 21 determines that there is not the product information (NO in step S85), it sends a transmission request for the product information to the upstream server 1 (step S88).

The transmission request for the product information is transmitted through the communication unit 26 to the upstream server 1. The communication unit 16 of the upstream server 1 receives the transmission request for the product information (step S89). The transmission request for the product information received by the communication unit 16 is outputted to the CPU 11. The CPU 11 stores the history of the transmission request for the product information in the history DB 153 as shown in FIG. 4 (step S91). Moreover, the date information outputted from the clock unit 18 is stored as the transmission request date in the history DB 153. The CPU 11 extracts the product information corresponding to the transmission request from the product information DB 154 (step S92).

The CPU 11 transmits the extracted product information through the communication unit 16 to the downstream server 2 (step S93). The CPU 21 of the downstream server 2 receives the product information received through the communication unit 26 (step S94). By using the product information stored beforehand in the product information DB 254 in the downstream server 2 in step S84 and the product information received in step S94, the CPU 21 executes processing according to the processing program 252 (step S95). The CPU 21 outputs the processing result to the display unit 24 etc. (step S96).

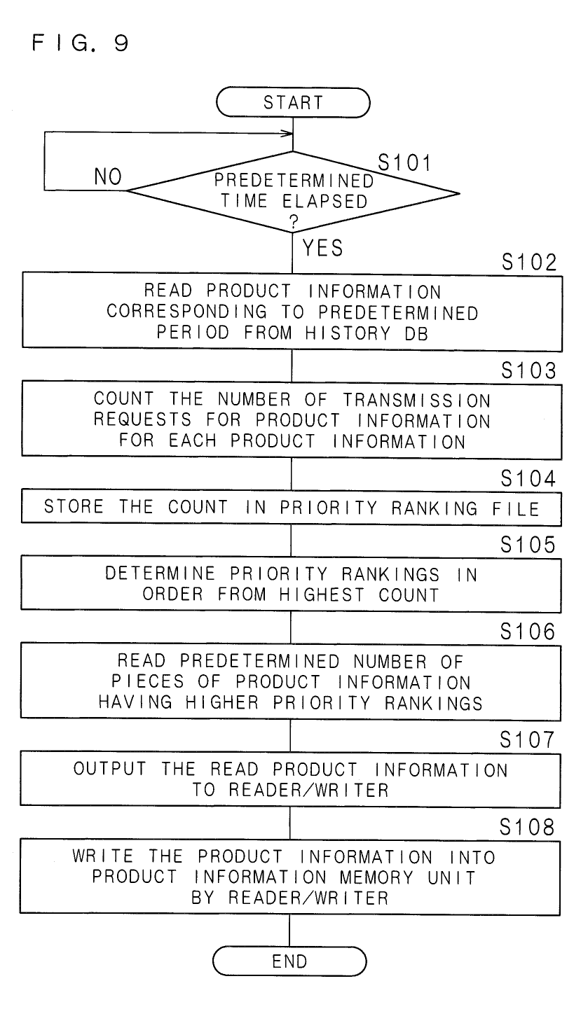

FIG. 9 is a flowchart showing the steps of the priority ranking determination process. The CPU 11 of the upstream server 1 refers to the output from the clock unit 18 and determines whether or not a predetermined time (for example, 24 hours) has elapsed (step S101). When the CPU 11 determines that the predetermined time has not elapsed (NO in step S101), it waits until the predetermined time elapses. On the other hand, when the CPU 11 determines that the predetermined time has elapsed (YES in step S101), it reads the product information corresponding to a predetermined period (for example, one week) from the history DB 153 (step S102). The CPU 11 counts for each product information the number of transmission requests made for the product information (step S103). More specifically, the CPU 11 counts the number of combinations matching the product name and item.

The CPU 11 stores the counted number in the priority ranking file 155 (step S104). As shown in FIG. 5, the CPU 11 determines priority rankings in order from the largest count (step S105). The CPU 11 reads a predetermined number of pieces of product information with higher priority rankings (step S106), and outputs the read product information to the reader/writer 29 (step S107). The reader/writer 29 writes the outputted product information into the product information memory unit 351 of the RF tag 3 (step S108). The timing of writing the product information into the product information memory unit 351 of the RF tag 3 is not limited to the above-mentioned timing. For example, it is possible to refer to the priority ranking file 155 when newly writing information into the product information memory unit 351 of the RF tag 3 and write a predetermined number of pieces of product information with higher priority rankings relating to the newly written information together. Moreover, it is possible to refer to the priority ranking files 155 and 255 when the RF tag 3 is read in the upstream server 1 or downstream server 2 and write a predetermined number of pieces of product information with higher priority rankings relating to the product information stored on the RF tag 3 into the product information memory unit 351 of the RF tag 3. Thus, information having higher priority rankings based on the history is written on a RF tag having small memory capacity on a priority basis. Hence, a processing burden of the selection device and the information processing device is reduced and a processing speed of the device and the information processing device improve. Also, since the priority ranking is not determined only by the selection device, even the downstream information processing device can provide information about modification of the priority ranking, thereby making it possible to more precisely select and obtain information to be written.

### Embodiment 2

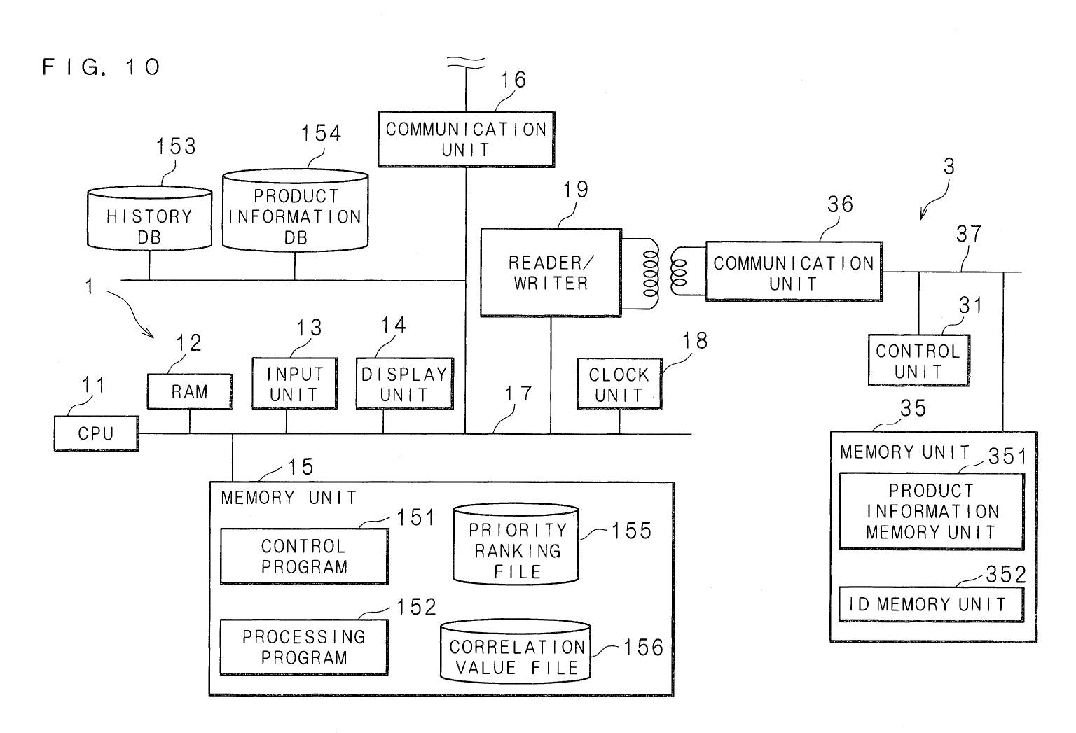

Embodiment 2 relates to a mode in which the priority ranking is changed based on the correlation between product information. FIG. 10 is a block diagram showing the hardware structures of the upstream server 1 and RF tag 3 according to Embodiment 2. In addition to the structure of Embodiment 1, a correlation value file 156 is stored in the memory unit 15. Note that although a similar correlation value file is stored in the downstream server 2, illustration thereof is omitted.

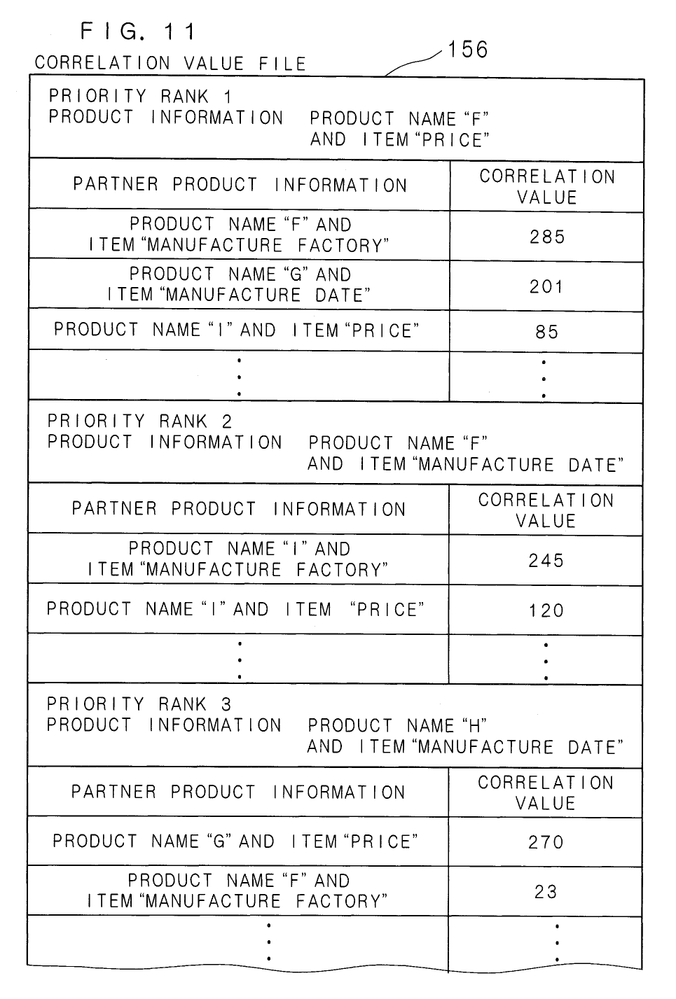

FIG. 11 is an explanatory view showing the record layout of the correlation value file 156. The CPU 11 refers to the history DB 153 at predetermined intervals and performs the process of changing the priority ranking stored in the priority ranking file 155. In the correlation value file 156, combinations of product information and partner product information for calculation of correlation values are stored in order of priority rankings, and a correlation value between product information and partner product information is stored for each combination. For example, for the product information corresponding to product name “F” and item “Price” which is ranked first in the priority rankings, the product name “F” and item “Manufacture Factory”, the product name “G” and item “Manufacture Date”, and the product name “I” and item “Price” are stored as the partner product information, and 285, 201, and 85 are stored as their correlation values, respectively. The greater the correlation value, the stronger the correlation between two pieces of product information.

Similarly, for the product information corresponding to product name “F” and item “Manufacture Date” which is ranked second in the priority rankings, correlation values with respect to the partner product information are stored. The CPU 11 reads a predetermined number of pieces of product information with higher priority rankings (for example, up to the fifth priority ranking) from the priority ranking file 155, and calculates correlation values with respect to other product information (partner product information) with reference to the history DB 153. Referring to the above specific example, the following will explain the process of calculating a correlation value. The CPU 11 extracts the product information corresponding to product name “F” and item “Price” which is ranked first in the priority rankings from the priority ranking file 155 and reads the transmission request date of the product information corresponding to product name “F” and item “Price” with reference to the history DB 153.

Then, the CPU 11 finds the differences between the read transmission request date and the transmission request dates for different product information, and extracts the product information having a difference equal to or smaller than a predetermined value (for example, 10 seconds) from the history DB 153. For a combination, for example, the CPU 11 extracts the product information corresponding to product name “F” and item “Manufacture Factory” or the product information corresponding to product name “I” and item “Price” for which transmission requests were made within 10 seconds after the transmission request for the product information corresponding to product “F” and item “Price” which is ranked first in the priority rankings. In other words, the CPU 11 extracts a combination of the product information corresponding to product name “F” and item “Price” and the product information corresponding to product name “F” and item “Manufacture Factory, or a combination of the product information corresponding to product name “F” and item “Price” and the product information corresponding to product name “I” and item “Price”. Since the transmission requests were made within a short time for these combinations, it is understood that these pieces of information have strong correlation.

Then, the CPU 11 counts the number of extracted combinations and stores the counted number of combinations as a correlation value into the correlation value file 156. As shown in FIG. 11, a combination of the product information “product name “F” and item “Price” and product name “F” and item “Manufacture Factory” (ranked sixth in the priority rankings)” has the highest correlation value “285”, and this combination is stored 285 times within 10 seconds in the history DB 153. Next, a combination of the product information “product name “H” and item “Manufacture Date” (ranked third in the priority rankings) and product name “G” and item “Price” (ranked seventh in the priority rankings)” has the second highest correlation value “270”.

For a predetermined number of combinations with higher correlation values, the CPU 11 executes the process of changing the priority ranking of product information with lower priority based on the priority ranking of product information with higher priority. For example, this process is carried out by changing the priority ranking of product information with lower priority to be equal to that of the product information with higher priority, or by calculating an average value of the priority rankings of both pieces of product information in the combination and changing the priority ranking of the product information with lower priority to be equal to the average value. The following will explain two combinations having higher correlation values with reference to an example of the process in which the priority ranking of product information with lower priority is changed to the average value of the priority rankings of both pieces of product information.

In this example, the process of changing the priority ranking is performed for a combination of “product name “F” and item “Price” and product name “F” and item “Manufacture Factory (ranked sixth in the priority rankings)” having the highest correlation value and a combination of “product name “H” and item “Manufacture Date” (ranked third in the priority rankings) and product name “G” and item “Price” (ranked seventh in the priority rankings)” having the second highest correlation value. As for the combination of “product name “F” and item “Price” and product name “F” and item “Manufacture Factory (ranked sixth in the priority rankings)” having the highest correlation value, the average value of priority rankings is 3.5. Therefore, the priority ranking of the product information corresponding to product name “F” and item “Manufacture Factory” is changed from the sixth to 3.5th. In this case, for the product information subject to change, the CPU 11 stores the changed priority ranking in the priority ranking file 155.

Next, since the average value of the combination of “product name “H” and item “Manufacture Date” (ranked third in the priority rankings) and the product name “G” and item “Price” (ranked seventh in the priority rankings)” having the second highest correlation value is 5, the priority ranking of the product information corresponding to product name “G” and item “Price” is changed from the seventh to fifth. Similarly, for the product information subject to change, the CPU 11 stores the changed priority ranking in the priority ranking file 155.

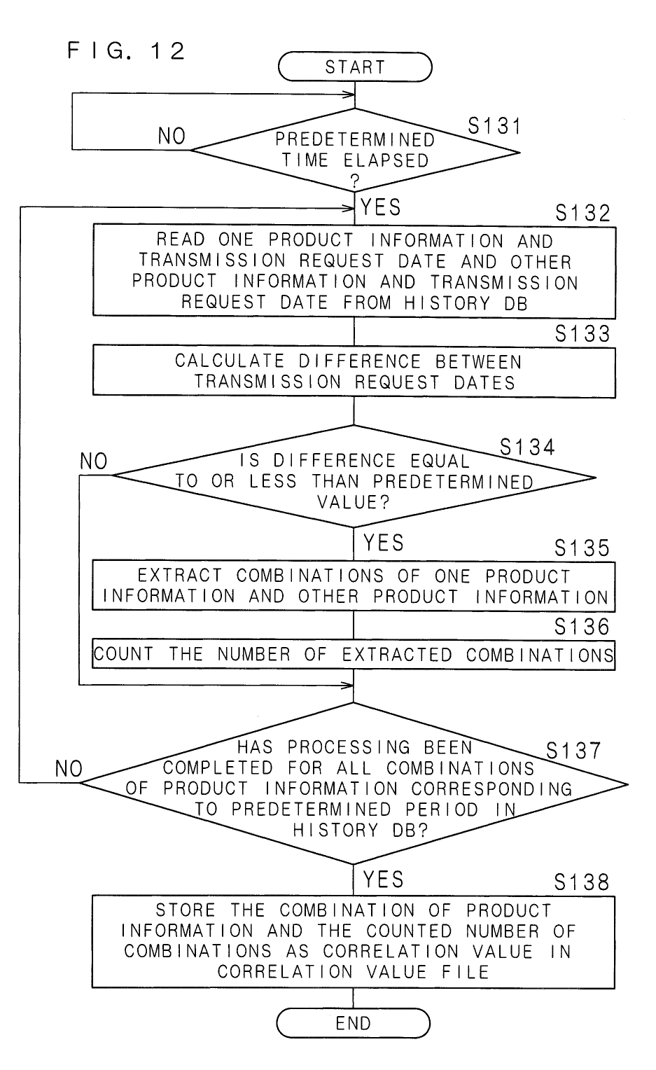

FIG. 12 is a flowchart showing the steps of the correlation value calculation process. The CPU 11 of the upstream server 1 refers to the output from the clock unit 18 and determines whether or not a predetermined time has elapsed (step S131). When the CPU 11 determines that the predetermined time has not elapsed (NO in step S131), it waits until the predetermined time elapses. On the other hand, when the CPU 11 determines that the predetermined time has elapsed (YES in step S131), it reads one product information and the transmission request date and other product information and the transmission request date from the history DB 153 (step S132).

The CPU 11 calculates the difference between the transmission request dates of the read product information (step S133). The CPU 11 determines whether or not the difference is equal to or less than a predetermined value (step S134). When the CPU 11 determines that the difference is equal to or less than the predetermined value (YES in step S134), it extracts the combination of one product information and other product information with a difference equal to or less than the predetermined value (step S135) and stores it in the RAM 12. Then, the CPU 11 counts the number of the combinations of the product information extracted in step S135 (step S136). The counted value is stored in the RAM 12 in association with the combination of product information.

On the other hand, when the CPU 11 determines in step S134 that the difference is not equal to or less than the predetermined value (NO in step S134), it skips the processes of steps S135 and S136. The CPU 11 determines whether or not the processes from steps S132 to S136 have been completed for all the combinations of product information corresponding to a predetermined period (for example, one week) in the history DB 153 (step S137). When the CPU 11 determines that the processes from steps S132 to S136 have not been completed for all the combinations of product information corresponding to the predetermined period (NO in step S137), it moves to step S132 and repeats the above-mentioned processes again. In this manner, combinations of correlated product information are counted one after another and their correlation value is found in step S136.

When the CPU 11 determines that the processes from steps S132 to S136 have been completed for all the combinations of product information (YES in step S137), it reads the respective combinations of product information and the number of the combinations stored in the RAM 12, and stores the combinations of product information and the counted numbers of the combinations as correlation values in the correlation value file 156 (step S138). Consequently, the correlation value file 156 shown in FIG. 11 is completed.

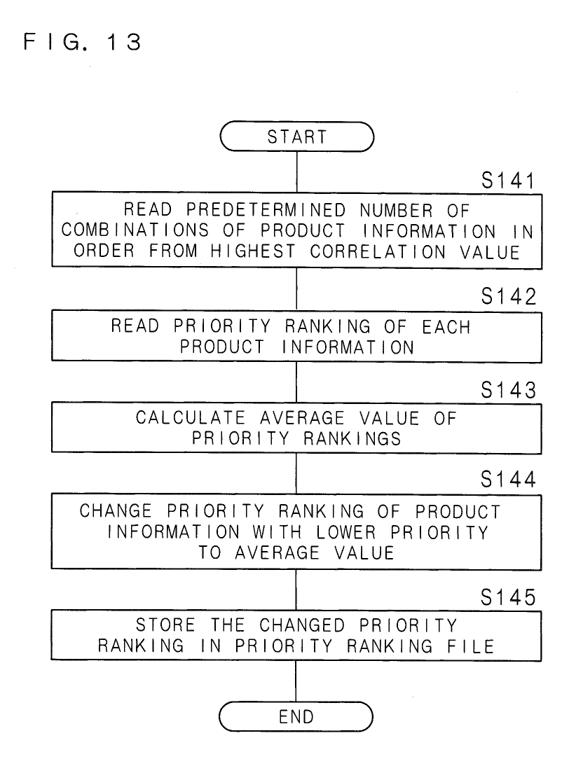

FIG. 13 is a flowchart showing the process of changing the priority ranking. After the above-mentioned process in step S138, the CPU 11 of the upstream server 1 performs the process of changing the priority ranking stored in the priority ranking file 155. The CPU 11 reads a predetermined number of combinations of product information in order from the highest correlation value from the correlation value file 156 (step S141). The CPU 11 reads from the priority ranking file 155 the priority ranking of each piece of product information having a higher correlation value read in step S141 (step S142).

The CPU 11 calculates the average value of priority rankings for each of the read combinations of product information (step S143). Then, the CPU 11 changes the priority ranking of product information with lower priority to the calculated average value (step S144). The CPU 11 stores the changed priority ranking in the priority ranking file 155 in association with the combination of the product information (step S145). By performing this process for all the combinations of product information read in step S141, the process of changing the priority ranking is completed.

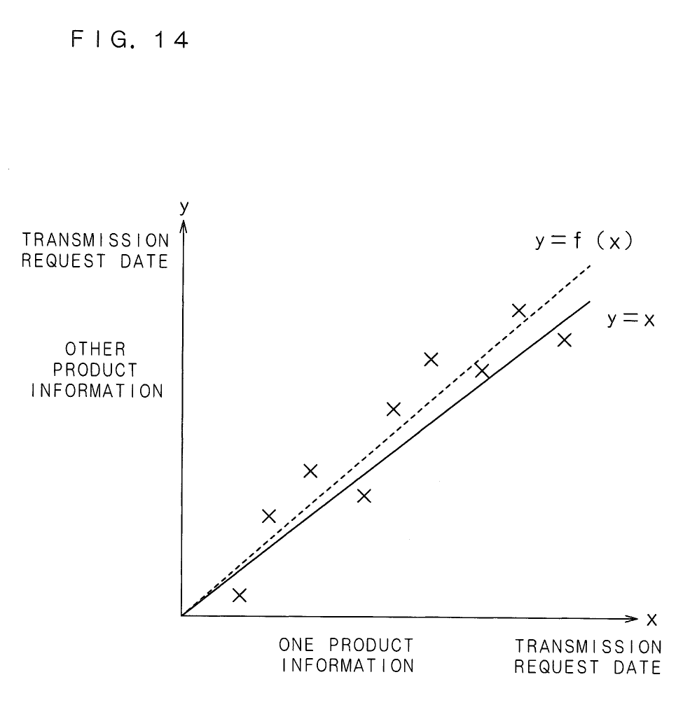

The correlation value calculation algorithm based on the transmission request dates of product information is merely one example, and it is possible to use the following algorithm. FIG. 14 is a graph showing the relationship between the transmission request dates of respective pieces of product information. In FIG. 14, the horizontal axis indicates the transmission request date of one product information and the vertical axis shows the transmission request date of other corresponding product information (partner product information). The plot indicated by x plots the transmission request dates of other product information for which transmission requests were made in association with the transmission request dates of one product information. More specifically, when a transmission request is made for other product information within a predetermined time (for example, one minute) from the transmission request date of one product information, the transmission request date of the other product information is plotted.

The dotted line in FIG. 14 is an approximate straight line (y=f(x)) found based on the plot indicated by x. The approximate straight line can be obtained by a known least square method. In FIG. 14, the solid line represents the function of y=x and is a straight line obtainable when the transmission request date of one product information matches the transmission request date of other product information. In other words, the closer the approximate straight line y=f(x) to the straight line y=x, the higher the correlation value between the product information. When the series s={sᵢ} of the approximate straight line y=f(x) and the series t={tᵢ} (i=1, 2, . . . n) of the straight line y=x are given, a correlation value R is calculated from equation (1) below.

$$R = \frac{{\sum }_{i = 1}^{n} ( {s}_{i} - {s}_{A} ) ( {t}_{i} - {t}_{A} )}{\sqrt{{\sum }_{i = 1}^{n} {( {s}_{i} - {s}_{A} )}^{2}} \sqrt{{\sum }_{i = 1}^{n} {( {t}_{i} - {t}_{A} )}^{2}}} \qquad ( 1 )$$

Here, s_{A} and t_{A} show the arithmetic mean of each of the series s={sᵢ} and the series t={tᵢ}. The CPU 11 calculates the correlation values for all the combinations of product information corresponding to the predetermined period stored in the history DB 153 and stores the calculated correlation values in the correlation value file 156. The correlation values take a value between −1 and +1. The closer the correlation coefficient to +1, the stronger the correlation between the product information in the same vector direction. The closer the correlation coefficient to 0, the weaker the correlation. Further, the closer the correlation value to −1, the stronger the correlation between the product information in opposite vector direction. The priority rankings are changed in order from the calculated largest correlation value.

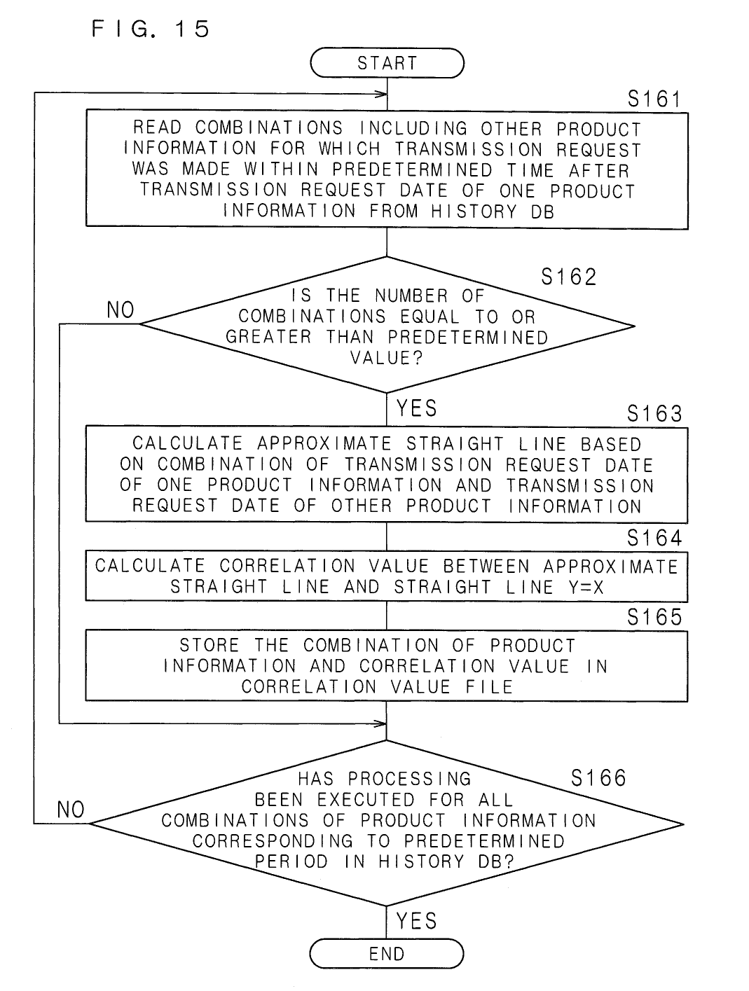

FIG. 15 is a flowchart showing the steps of the correlation value calculation process. The CPU 11 reads, from the history DB 153, combinations of other product information for which transmission requests were made within a predetermined time (for example, one minute) from the transmission request date of one product information (step S161). The CPU 11 determines whether or not the number of the combinations is equal to or more than a predetermined number (for example, 5) (step S162). This is because the reliability of the approximate straight line is lower if the number of samples is small. When the CPU 11 determines that the number of the combinations is equal to or more than the predetermined number (YES in step S162), it calculates an approximate straight line using the least square method, based on the combination of the transmission request date of the one product information and the transmission request date of the other product information (step S163).

The CPU 11 calculates a correlation value between the calculated approximate line and a straight line y=x by using Equation (1) stored in the memory unit 15 (step S164). The CPU 11 stores the combination of the product information and the correlation value in the correlation value file 156 (step S165). After the process in step S165 and when the CPU 11 determines in step S162 that the number of combinations is not equal to or more than the predetermined value (NO in step S162), the CPU 11 determines whether or not the processes from steps S161 to S165 have been executed for all the combinations of product information corresponding to the predetermined period in the history DB 153 (step S166). When the CPU 11 determines that the processes have not been executed for all the combinations of product information corresponding to the predetermined period (NO in step S166), it moves to step S161 and repeats the above-mentioned processes again. On the other hand, when the CPU 11 determines that the processes have been executed for all the combinations (YES in step S166), it finishes the sequence of processes. Hence, the priority ranking is changed based on the correlation between the product information. As a result, since product information pieces having strong correlation are stored together in the memory, the present invention provides advantageous effects, such as enabling more efficient use of product information.

Embodiment 2 has the above-mentioned structure. Since other structures and functions are similar to those in Embodiment 1, the same reference numbers are assigned to the corresponding sections, and the detailed explanation thereof is omitted.

### Embodiment 3

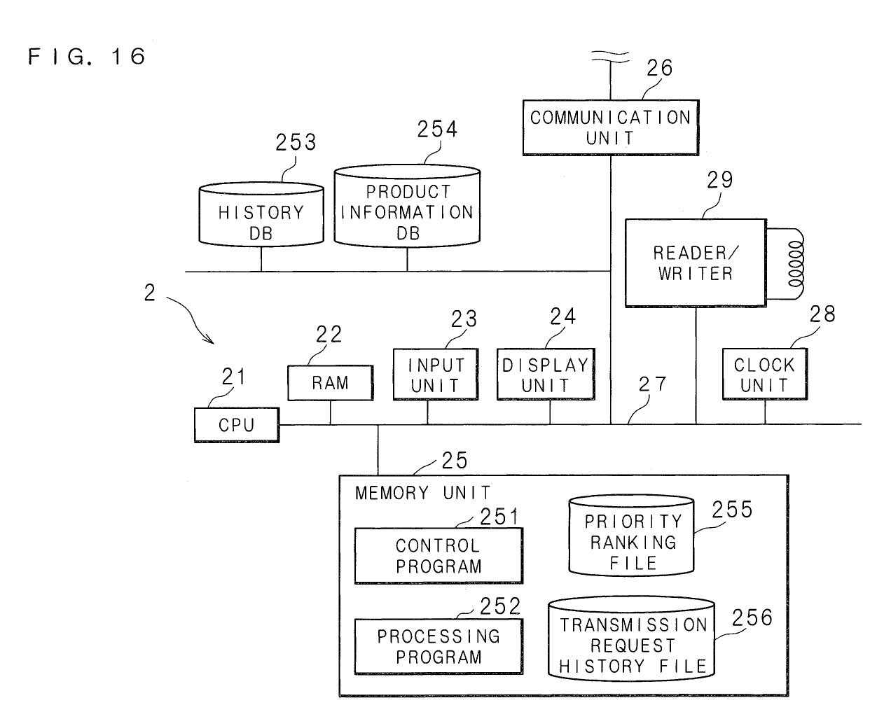

Embodiment 3 relates to a mode in which predetermined information is transmitted from the downstream server 2 to the upstream server 1 in order to modify the priority rankings. FIG. 16 is an explanatory view showing the hardware structure of the downstream server 2 according to Embodiment 3. In addition to the structure of Embodiment 1, a transmission request history file 256 is stored in the memory unit 25 of the downstream server 2 of Embodiment 3. Whenever the CPU 21 of the downstream server 2 sends a transmission request for product information, it stores the history in the transmission request history file 256.

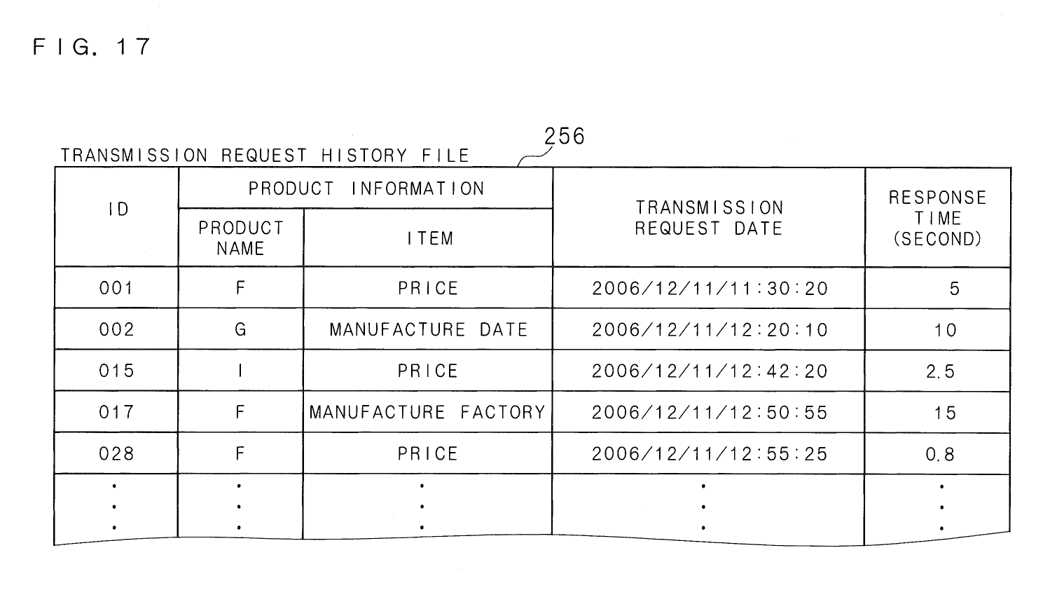

FIG. 17 is an explanatory view showing the record layout of the transmission request history file 256. The transmission request history file 256 includes the ID field, Product Name field, Item field, Transmission Request Date field, and Response Time field. In the ID field, the ID of a RF tag corresponding to product information for which the transmission request was made is stored. In the Product Name field and Item field, the product name and item are stored as product information in association with the ID. In the Transmission Request Date field, the information about the time at which the transmission request was made is stored. In the Response Time field, the time required to receive product information from the transmission of a transmission request to the upstream server 1 is stored as the response time. For example, as for the product information corresponding to product name “F” and item “Price”, when the transmission request date is 2006/12/11/11:30:20 and the date at which the product information was received from the upstream server 1 is 2006/12/11/11:30:25, then the response time is 5 seconds. Note that the information about the reception date is obtainable from the output from the clock unit 28.

The CPU 11 refers to the transmission request history DB 256 after the elapse of a predetermined time and calculates the average time of response time for each product information. Then, the CPU 11 transmits to the upstream server 1 a predetermined number of pieces of (for example, one) product information having longer average time as the product information that requires a modification of priority ranking. When the CPU 11 of the upstream server 1 receives the product information to be modified, it raises the priority ranking of the received product information by a predetermined number. For example, when the average value of response time of the product information corresponding to product name “G” and item “Manufacture Date” is longest “20 seconds”, the CPU 21 of the downstream server 2 transmits the product name “G” and item “Manufacture Date” as the product information to be modified. When transmitting the data, the CPU 11 adds in the header the information indicating that the data is to be modified.

When the CPU 11 of the upstream server 1 receives the product information to be modified, it reads the priority ranking from the priority ranking file 155. In this example, the priority ranking of the product name “G” and item “Manufacture Date” is twelfth. The CPU 11 subtracts the coefficient stored beforehand in the memory unit 15 from the read priority ranking to calculate a modified priority ranking. The CPU 11 stores the calculated modified priority ranking in the priority ranking file 155. Thus, since there is a higher possibility that the product information which requires communication time is stored on the RF tag 3, it is possible to increase the overall processing speed.

86ion, it is possible to modify product information having a higher count of transmission requests. In this case, the CPU 11 refers to the transmission request history file 256, sorts the data by using two fields: Product Name and Item, and counts the number of transmission requests for each product information. Then, the CPU 11 transmits to the upstream server 1 a predetermined number of pieces of product information with higher counts as product information to be modified. Further, the CPU 11 can decide product information to be modified, based on a value calculated based on both the response time and the count of outputted transmission requests. In this case, it is possible to multiply the number of transmission requests by the average value of response time and define a predetermined number of pieces of product information having larger values from the multiplication as the product information to be modified.

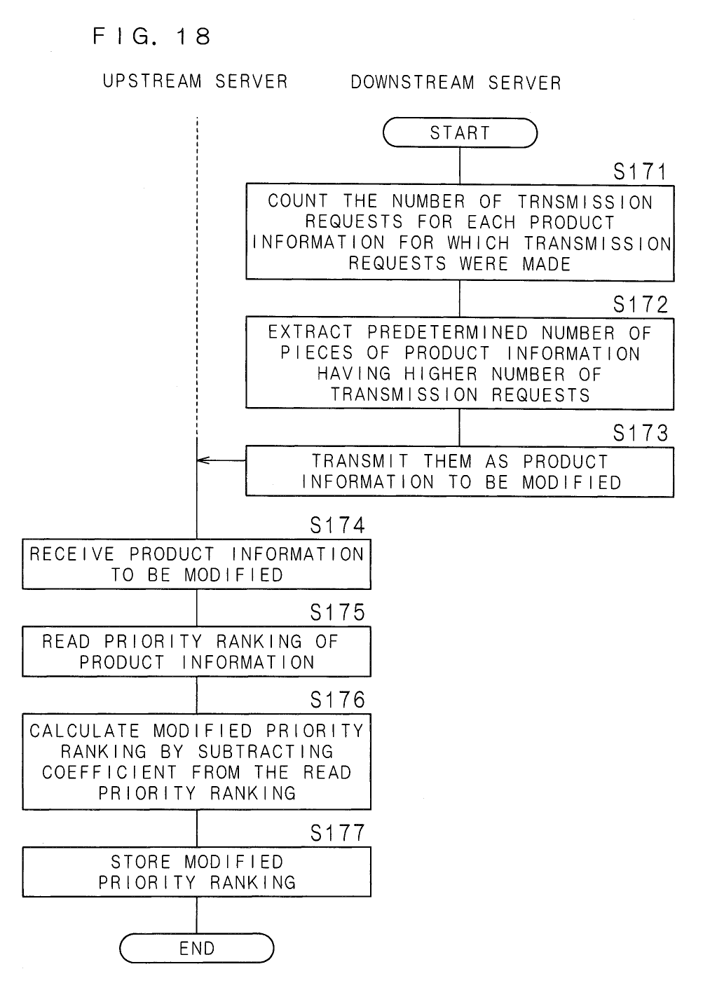

FIG. 18 is a flowchart showing the steps of the process of modifying the priority ranking based on the number of transmission requests. The CPU 21 of the downstream server 2 refers to the transmission request history file 256 and counts the number of transmission requests for each product information for which transmission requests were made (step S171). Then, the CPU 21 extracts a predetermined number of pieces of product information having a higher number of transmission requests (step S172). The CPU 21 transmits the extracted product information as product information to be modified through the communication unit 26 to the upstream server 1 (step S173).

The CPU 11 of the upstream server 1 receives the transmitted product information to be modified (step S174). Since the product information transmitted in step S173 has a description in the header that the priority ranking is to be modified, the CPU 11 performs the following modification process. The CPU 11 reads the priority ranking corresponding to the product information received in step S174 from the priority ranking file 155 (step S175). Then, the CPU 11 subtracts the coefficient stored beforehand in the memory unit 15 from the read priority ranking to calculate a modified priority ranking (step S176). The CPU 11 stores the calculated modified priority ranking in the priority ranking file 155 (step 177).

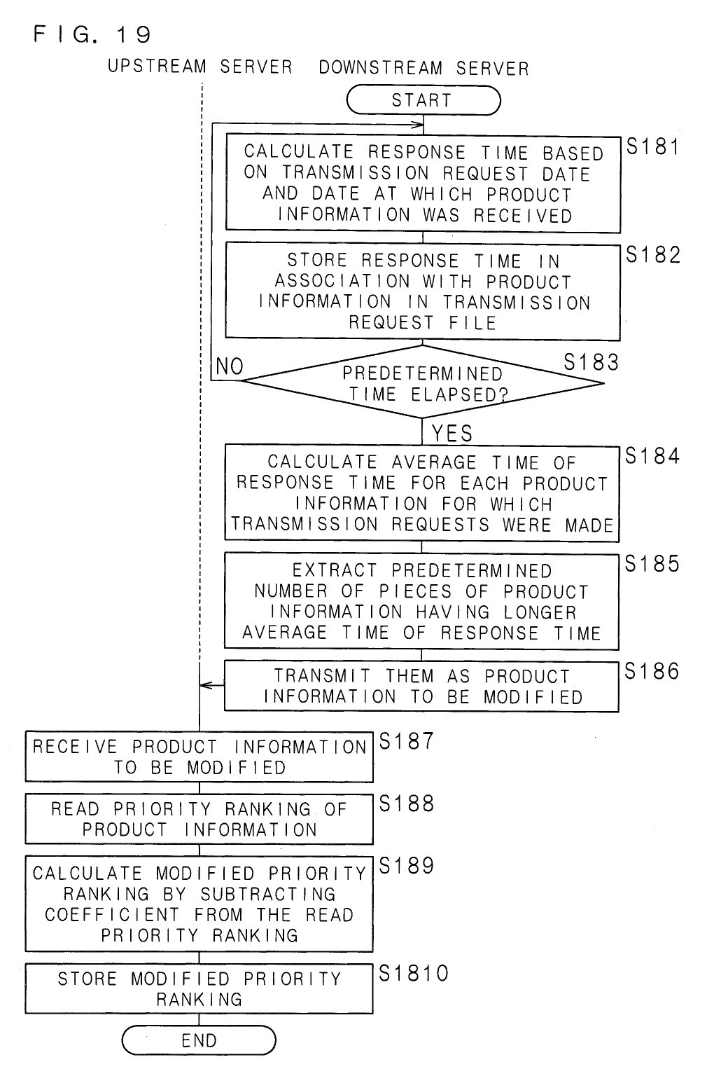

FIG. 19 is a flowchart showing the steps of the process of modifying the priority ranking based on the response time. The CPU 21 of the downstream server 2 calculates the response time based on the transmission request date at which a transmission request for product information was made and the date at which the product information was received in response to the transmission request (step S181). The CPU 21 stores the response time in association with the product information in the transmission request history file 256 (step S182). The CPU 21 refers to the output from the clock unit 28 and determines whether or not a predetermined time has elapsed (step S183). When the CPU 21 determines that the predetermined time has not elapsed (NO in step S183), it moves to step S181 and repeats the above-mentioned process. On the other hand, when the CPU 21 determines that the predetermined time has elapsed (YES in step S183), it refers to the transmission request history file 256 and calculates an average time of response time for each product information for which transmission requests were made (step S184). Then, the CPU 21 extracts a predetermined number of pieces of product information having longer average time of response time (step S185).

The CPU 21 transmits the extracted product information as product information to be modified to the upstream server 1 through the communication unit 26 (step S186). The CPU 11 of the upstream server 1 receives the transmitted product information to be modified (step S187). Since the product information transmitted in step S186 has a description indicating in the header that the priority ranking is to be modified, the CPU 11 performs the following modification process. The CPU 11 reads the priority ranking corresponding to the product information received in step S187 from the priority ranking file 155 (step S188). Then, the CPU 11 subtracts the coefficient stored beforehand in the memory unit 15 from the read priority ranking to calculate a modified priority ranking (step S189). The CPU 11 stores the calculated modified priority ranking in the priority ranking file 155 (step S1810).

Embodiment 3 has the above-described structure. Since other structures and functions are similar to those in Embodiments 1 and 2, the same reference numbers are assigned to the corresponding sections, and the detailed explanation thereof is omitted.

### Embodiment 4

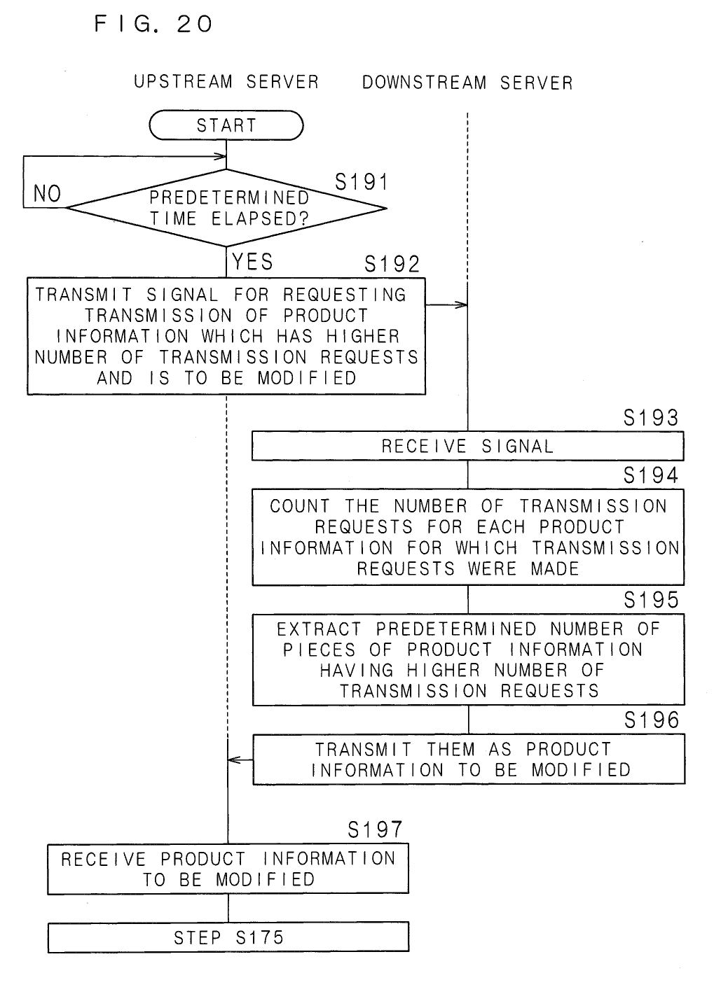

Embodiment 4 relates to a mode in which the upstream server 1 asks the downstream server 2 at predetermined intervals whether or not there is product information subject to modification of priority ranking. FIG. 20 is a flowchart showing the steps of the process of modifying the priority ranking according to Embodiment 4. The CPU 11 of the upstream server 1 refers to the output from the clock unit 18 and determines whether or not a predetermined time has elapsed (step S191). When the CPU 11 determines that the predetermined time has not elapsed (NO in step S191), it waits until the predetermined time elapses. On the other hand, when the CPU 11 determines that the predetermined time has elapsed (YES in step S191), it transmits to the downstream server 2 a signal for requesting transmission of product information which has a higher count of transmission requests and is to be modified (step S192). The code of the signal can be determined between the upstream server 1 and downstream server 2 in advance.

The CPU 21 of the downstream server 2 receives the signal requesting transmission of product information which has a higher count of transmission requests and is to be modified (step S193). Then, the CPU 21 refers to the transmission request history file 256 and counts the number of transmission requests for each product information for which the transmission requests were made (step S194). The CPU 21 extracts a predetermined number of pieces of product information having a higher number of transmission requests (step S195). The CPU 21 transmits the extracted product information as product information to be modified to the upstream server 1 through the communication unit 26 (step S196). The CPU 11 of the upstream server 1 receives the transmitted product information to be modified (step S197). Since the following process is similar to the process after step S175 of Embodiment 3, the detailed explanation is omitted.

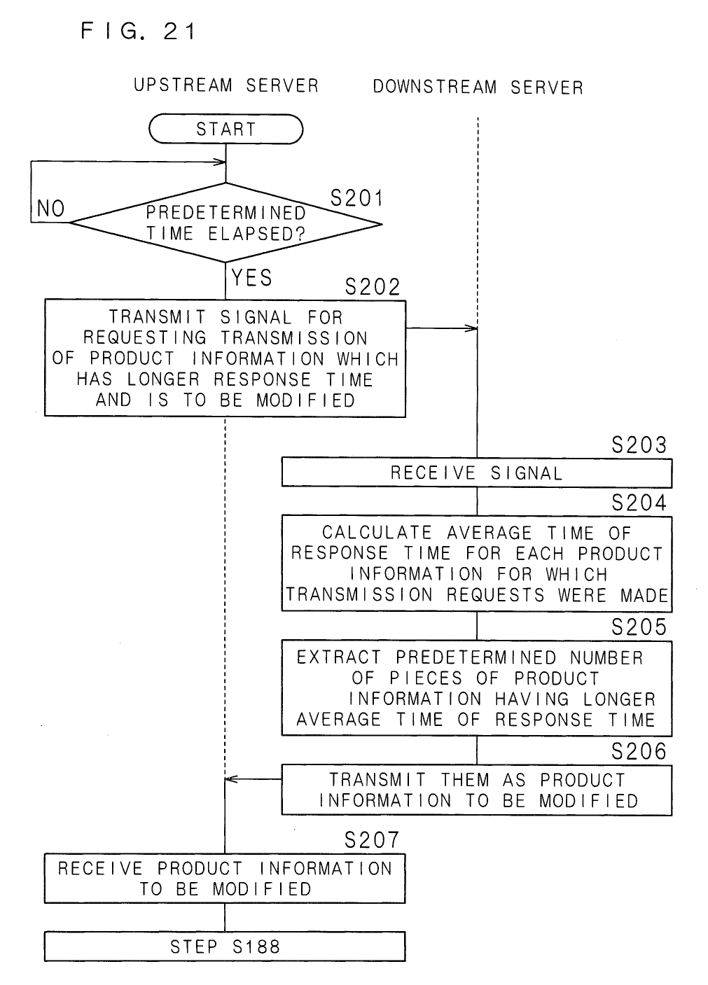

FIG. 21 is a flowchart showing the steps of the process of modifying the priority ranking according to Embodiment 4. The CPU 11 of the upstream server 1 refers to the output from the clock unit 18 and determines whether or not a predetermined time has elapsed (step S201). When the CPU 11 determines that the predetermined time has not elapsed (NO in step S201), it waits until the predetermined time elapses. On the other hand, when the CPU 11 determines that the predetermined time has elapsed (YES in step S201), it transmits to the downstream server 2 a signal for requesting transmission of product information which has longer response time and is to be modified (step S202). The code of the signal can be determined between the upstream server 1 and downstream server 2 in advance separately from the code transmitted in step S192.

The CPU 21 of the downstream server 2 receives the signal requesting transmission of product information which has longer response time and is to be modified (step S203). Then, the CPU 21 refers to the transmission request history file 256 and calculates an average time of response time for each product information for which transmission requests were made (step S204). The CPU 21 extracts a predetermined number of pieces of product information having longer average time of response time (step S205).

The CPU 21 transmits the extracted product information as product information to be modified to the upstream server 1 through the communication unit 26 (step S206). The CPU 11 of the upstream server 1 receives the transmitted product information to be modified (step S207). Since the following process is similar to the process after step S188 of Embodiment 3, the detailed explanation is omitted.

Embodiment 4 has the above-described structure, and since other structures and functions are similar to those in Embodiments 1 to 3, the same reference numbers are assigned to the corresponding sections and the detailed explanation thereof is omitted.

### Embodiment 5

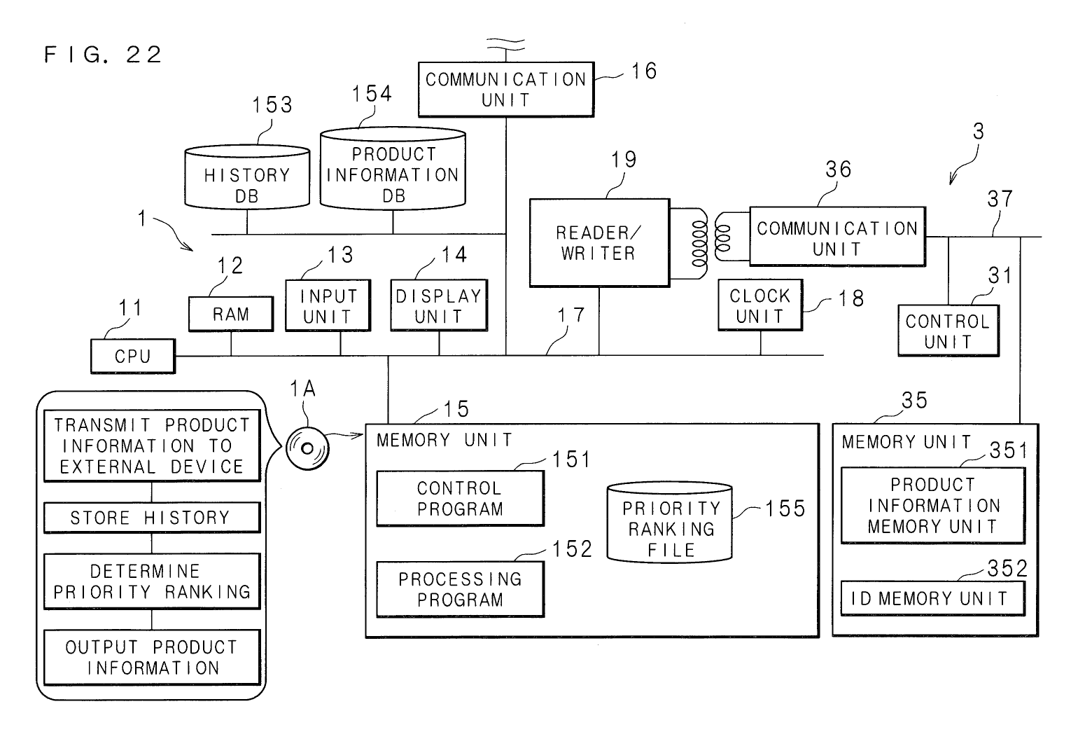

FIG. 22 is a block diagram showing the structure of the upstream server 1 according to Embodiment 5. It is possible to provide a program for activating the upstream server 1 according to Embodiment 5 by a removable recording medium A, such as a CD-ROM, as illustrated in FIG. 22. It is also possible to download the computer program from a server computer, not shown, through the communication network N. The contents will be explained below.

The removable recording medium 1a storing a program for causing the upstream server 1 to transmit product information to an external device, store the history, determine the priority rankings and output the product information is inserted into a recording medium reader, not shown, of the upstream server 1 shown in FIG. 22, and the program is installed in a control program 151 in the memory unit 15. Alternatively, it is possible to download the program from an external server computer, not shown, through the communication unit 16 and install the program in the memory unit 15. The program is loaded in the RAM 12 and executed. Hence, the program functions as the above-described upstream server 1 of the present invention.

Moreover, in order to cause the upstream server 1 to also function as the downstream server 2, it is possible to store a program for causing the upstream server 1 to function as the downstream server 2 in the removable recording medium 1A. In this case, the removable recording medium 1A further stores a program for storing product information and outputting a transmission request for the product information to an external device. By installing this program in the control program 151 in the memory unit 15, the upstream server 1 functions as a server that performs both the functions of the upstream server 1 and downstream server 2. It is also possible to download this additional program from a server computer, not shown, through the communication unit 16.

Embodiment 5 has the above-described structure. Since other structures and functions are similar to those in Embodiments 1 to 4, the same reference numbers are assigned to the corresponding sections and the detailed explanation thereof is omitted.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A selection method for selecting, using a selection device and an information processing device connected through a communication network, product information to be written on a wireless tag from a memory unit of the selection device, comprising:
a step of transmitting product information stored in the memory unit of the selection device to the information processing device when the selection device receives a transmission request for product information from the information processing device;
a storing step of storing a history of the received transmission request for product information in a history database by the selection device;
a determination step of determining priority rankings for product information by the selection device, based on the history stored in the history database; and
a step of reading a predetermined number of pieces of product information having higher priority rankings determined in the determination step from the memory unit and outputting the product information as information to be written on a wireless tag from the selection device to a wireless tag writing device.

2. A selection system comprising a selection device for selecting product information to be written on a wireless tag from a memory unit storing a plurality of pieces of product information, and an information processing device connected to said selection device through a communication network, wherein
said selection device comprises:
the memory unit; and
a processor for executing a process comprising:
a step of transmitting product information stored in the memory unit to said information processing device when said selection device receives a transmission request for product information from said information processing device;
a storing step of storing a history of the received transmission request for product information in a history database;
a determination step of determining priority rankings for product information, based on the history stored in the history database; and
a step of outputting a predetermined number of pieces of product information having higher priority rankings determined in the determination step to a wireless tag writing device as information to be written on a wireless tag.

3. The selection system according to claim 2, wherein
said information processing device is connected to a reading device for reading information on a wireless tag, and
said information processing device comprises a processing unit for executing a process comprising:
a step of storing product information on a wireless tag outputted from the reading device into a database for storing product information; and
a request output step of outputting a transmission request for product information to said selection device if product information necessary for said processing unit to execute various processing using product information stored in the database is not stored in the database.

4. The selection system according to claim 3, wherein
the processing unit of said information processing device executes a process comprising:
a count step of counting the number of transmission requests for product information outputted to said selection device in the request output step; and
a count transmission step of transmitting a predetermined number of pieces of product information having higher counts counted in the count step to said selection device, and
a processor of said selection device executes a modification step of modifying the priority ranking determined in the determination step for the product information having higher count transmitted in the count transmission step.

5. The selection system according to claim 3, wherein
the processing unit of said information processing device executes a process comprising:
a step of storing in a transmission request history file a response time required until product information is received after outputting a transmission request for the product information to said selection device in association with the product information; and
a response time transmission step of transmitting a predetermined number of pieces of product information having longer response time stored in the transmission request history file from said information processing device to said selection device, and
the processor of said selection device executes a modification step of modifying the priority ranking determined in the determination step for the product information having longer response time transmitted in the response time transmission step.

6. The selection system according to claim 4, wherein
the processor of said selection device executes a process comprising:
a step of transmitting at predetermined intervals to said information processing device a signal for requesting transmission of product information having a higher count in the count transmission step, and
wherein upon receipt of the signal, the count transmission step transmits a predetermined number of pieces of product information having higher counts counted in the count step to said selection device.

7. The selection system according to claim 5, wherein
the processor of said selection device executes a step of transmitting at predetermined intervals to said information processing device a signal for requesting transmission of product information having longer response time in the response time transmission step, and
wherein upon receipt of the signal, the response time transmission step transmits a predetermined number of pieces of product information having longer response time stored in the transmission request history file to said selection device.

8. A selection device for selecting product information to be written on a wireless tag, comprising:
a memory unit; and
a processor for executing a process comprising:
a step of transmitting product information stored in the memory unit to an external device upon receipt of a transmission request for product information from the external device;
a storing step of storing a history of the received transmission request for product information in a history database;
a determination step of determining priority rankings for product information, based on the history stored in the history database; and
a step of outputting a predetermined number of pieces of product information having higher priority rankings determined in the determination step to the external device as information to be written on a wireless tag.

9. The selection device according to claim 8, wherein
the determination step determines the priority rankings in order from the product information having highest number of transmission requests in the history of transmission requests for product information stored in the history database.

10. The selection device according to claim 8, wherein
the storing step stores the history of the received transmission requests for product information together with transmission request dates in the history database, and
said processor executes a process comprising:
a correlation value calculation step of calculating a correlation value between one product information and other product information, based on the transmission request dates stored in the history database; and
a change step of changing the priority ranking of product information determined in the determination step for one product information or other product information having a higher correlation value calculated in the correlation value calculation step, based on the priority ranking of either the one product information or the other product information.

11. The selection device according to claim 10, wherein
the correlation value calculation step comprises:
an extraction step of extracting a combination of one product information and other product information having a difference equal to or smaller than a predetermined value between the transmission request date of the one product information and the transmission request date of the other product information with reference to the history database;
a step of counting the number of combinations of one product information and other product information extracted in the extraction step; and
a step of outputting the number of combinations counted in the count step as a correlation value between the one product information and other product information.

12. The selection device according to claim 10, wherein
the change step changes the priority ranking of product information determined in the determination step for one product information or other product information having a higher correlation value calculated in the correlation value calculation step to the priority ranking of either the one product information or the other product information having higher priority.

13. A selection device for selecting product information to be written on a wireless tag, comprising:
means for transmitting product information stored in a memory unit to an external device upon receipt of a transmission request for product information from the external device;
memory means for storing a history of the received transmission request for product information in a history database;
determining means for determining priority rankings for product information, based on the history stored in the history database; and
means for outputting to the external device a predetermined number of pieces of product information having higher priority rankings determined by said determining means as information to be written on a wireless tag.

14. A recording medium readable by a computer and storing a program for causing a computer to select product information to be written on a wireless tag and execute a process comprising:
a step of transmitting product information stored in a memory unit to an external device upon receipt of a transmission request for product information from the external device;
a storing step of storing a history of the received transmission requests for product information in a history database;
a determination step of determining priority rankings for product information, based on the history stored in the history database; and
a step of outputting a predetermined number of pieces of product information having higher priority rankings determined in the determination step to the external device as product information to be written on a wireless tag.

15. The recording medium of claim 14, wherein
the program causes the computer to execute a process comprising:
a step of storing product information on a wireless tag outputted from an external device into a database for storing product information; and
a request output step of outputting a transmission request for product information to an external device when a processing section for executing various processing using product information stored in the database determines that product information necessary for executing the processing is not stored in the database.
